(19) United States
(12) Patent Application Publication
(10) Pub. No.: US 2026/0281177 A1
(43) Pub. Date: Sep. 17, 2026

(54) APPARATUS, METHOD AND COMPUTER READABLE STORAGE MEDIUM FOR COMMUNICATION

(71) Applicant: Huawei Technologies Co., Ltd., Shenzhen (CN)

(72) Inventors: Weisen Shi, Kanata (CA); Xu Li, Nepean (CA); Chenchen Yang, Ottawa (CA); Hang Zhang, Ottawa (CA)

(21) Appl. No.: 19/657,957

(22) Filed: Apr. 24, 2026

Related U.S. Application Data
(63) Continuation of application No. PCT/CN2024/080855, filed on Mar. 8, 2024.
(60) Provisional application No. 63/594,056, filed on Oct. 30, 2023.

(51) Int. Cl. H04L 67/1095; H04L 67/1001

(52) U.S. Cl. CPC H04L 67/1095; H04L 67/1001

(57) ABSTRACT

Embodiments of the present application provide apparatus, method and computer readable storage medium for communication. In an example method, a mission management (MM) network element determines that a processing service function (PSF) network element meets a re-location condition. The MM network element may then instruct a task control function (TCF) network element managing the PSF network element, to switch the sub-task executed on the PSF network element to another PSF network element for execution by sending a re-location request.

### CROSS-REFERENCE TO RELATED APPLICATIONS

This application is a continuation of International Patent Application No. PCT/CN2024/080855, filed on Mar. 08, 2024, which claims the benefits of U.S. Provisional Application No. 63/594,056, filed on Oct. 30, 2023, the disclosures of which are hereby incorporated by reference in their entireties.

### TECHNICAL FIELD

The present disclosure relates to the field of wireless communications, and particularly to an apparatus, method and computer readable storage medium for communication.

### BACKGROUND

When a device accesses an application through a communication system, e.g. the 5G system or future 6G system, the communication system connects the device to an application location, a network location where the application is located, through a data plane path. The application location corresponds to an application server hosting or running the application. When the device accesses the application, the device communicates with the application server through the data plane path. There may be more than one application location. When multiple devices access the application, the communication system may connect the multiple devices to different application locations.

### SUMMARY

In this disclosure, an apparatus, method and computer readable storage medium for communication, in which sub-task(s) can be executed more effectively and the resources in communication system can be balanced.

A first aspect of the disclosure involves an apparatus, comprising: one or more processors, wherein the one or more processors are configured to: receive, from a mission management (MM) network element in a communications system, a re-location request, wherein the MM network element is configured to manage execution of a first mission, and a first sub-task in a first task of the first mission is executed on a first processing service function (PSF) network element; switch the first sub-task to a second PSF network element for execution in response to the re-location request, wherein the first PSF network element and the second PSF network element are managed by the apparatus.

In some embodiments of the first aspect, the apparatus may switch the first sub-task from the first PSF network element (e.g. o-PSF in the description part) to the second PSF network element (e.g. n-PSF in the description part) for execution with the re-location request form the MM network element. That is, if the resource in the communication system is not balance or the resource available for the first PSF network element is not enough to execute the first sub-task or in other seniors, the apparatus may switch the first sub-task to the second PSF network element for execution. Hence the first sub-task can be executed more effectively and the resources in communication system can be balanced.

In some embodiments of the first aspect, the apparatus may be logic or physical network element with the task control function (TCF) (or other function has similar or same function with the TCF) in the description part deployed.

One or more embodiments according to the apparatus in the first aspect, the switch the first sub-task to a second PSF network element for execution, comprising: send, to the first PSF network element, a first synchronization request instructing the first PSF network element to synchronize execution data of the first sub-task to the second PSF network element.

In those embodiments, the execution data of the first sub-task obtained by the first PSF network element may be synchronized to the second PSF, and the second PSF network element may execute the first sub-task based on the synchronized execution data, which may improve the executing efficiency of the first sub-task.

One or more embodiments according to the apparatus in the first aspect, wherein: the switch the first sub-task to a second PSF network element for execution, comprising: send, to the second PSF network element, a second synchronization request instructing the second PSF network element to obtain the execution data of the first sub-task from the first PSF network element.

In those embodiments, the synchronization procedure may be triggered by the second PSF network element.

One or more embodiments according to the apparatus in the first aspect, wherein: the execution data comprises at least one of the following information: PSF network element information of a PSF network element executing a task associated with the first sub-task; execution progress of the first sub-task; or intermediate data obtained by the first PSF network element by executing the first sub-task.

One or more embodiments according to the apparatus in the first aspect, wherein the one or more processors are further configured to: send, to the second PSF network element before sending the first synchronization request to the first PSF network element or before sending the second synchronization request to the second PSF network element, a first configuration request instructing the second PSF network element to configure execution parameter.

In those embodiments, the apparatus may send a first configuration request to the second PSF network element, hence the second PSF network element may configure execution parameter(s) to replace the function of the first PSF network element.

One or more embodiments according to the apparatus in the first aspect, wherein: the execution parameter comprises at least one of the following parameter: session identifier of a connected data session, data forwarding rule, or data synchronization rule.

One or more embodiments according to the apparatus in the first aspect, wherein: the apparatus further manages one or more third PSF network elements executing a second task associated with the first sub-task; and the one or more processors are further configured to: send, to the one or more third PSF network elements before sending the first configuration request to the second PSF network element, a first PSF execution customize request instructing the one or more third PSF network elements to suspend execution of the second task.

In those embodiments, the apparatus may send PSF execution customize request to the third PSF network element(s) (e.g. r-PSF in the description part), hence the third PSF network elements may suspend execution of the second task associated with the first sub-task, which may avoid the re-location procedure affect the execution of the second task.

One or more embodiments according to the apparatus in the first aspect, wherein the first PSF execution customize request further instructs the one or more third PSF network elements to: switch a first data forwarding relationship with the first PSF network element to a second data forwarding relationship with the second PSF network element, and/or resume execution of the second task after suspended for a first duration.

In those embodiments, the third PSF network element may also switch a first data forwarding relationship with the first PSF network element to a second data forwarding relationship with the second PSF network element. Hence the data which should be transmitted to the first PSF network element may be transmitted to the second PSF network element, and/or the data which should be received from the first PSF network element may be received from the second PSF, which can ensure the execution of the second task. Besides, the third PSF network element may resume execution of the second task after suspended for a first duration (e.g. after the first sub-task is switched to the second PSF network element for execution).

One or more embodiments according to the apparatus in the first aspect, wherein: the first configuration request is sent to the second PSF network element after receiving a response corresponding to the first customize request.

One or more embodiments according to the apparatus in the first aspect, wherein the one or more processors are further configured to: receive, from the first PSF network element and/or the second PSF network element, a synchronization response; send, to the MM network element in response to the synchronization response, a re-location response instructing the MM network element to resume execution of a third task; wherein the third task was suspended before the first sub-task is switched to the second PSF network element for execution, and the third task is associated with the first sub-task.

In those embodiments, the apparatus may send re-location response to the MM network element after the first sub-task is switched to the second PSF network element for execution, hence the MM network element may resume the execution of the third task associated with the first sub-task, which may improve the execution efficiency of the third task.

One or more embodiments according to the apparatus in the first aspect, wherein: the one or more processors are further configured to: receive, from the first PSF network element and/or the second PSF network element, a synchronization response; send, to the one or more third PSF network elements, a resume execution request instructing the one or more third PSF network elements to resume execution of the second task.

In those embodiments, the apparatus may send resume execution request to the third PSF after the first sub-task is switched to the second PSF network element for execution, hence the third PSF network element may resume the execution of the second task associated with the first sub-task, which may improve the execution efficiency of the second task.

One or more embodiments according to the apparatus in the first aspect, wherein: the second PSF network element is determined by the apparatus based on performance parameter of PSF network elements managed by the apparatus, and the performance parameter comprises at least one of the following parameters: available communication resource, available computing resource, or network location.

In those embodiments, the apparatus may determine the second PSF network element from PSF network element managed by the apparatus based on the aforementioned parameters.

One or more embodiments according to the apparatus in the first aspect, wherein the re-location request comprises a first identifier of the first PSF network element and a second identifier of the second PSF network element.

In those embodiments, the second PSF may be determined by the MM network element, and the MM network element may send the identifier of the second PSF to the apparatus.

One or more embodiments according to the apparatus in the first aspect, wherein the re-location request is sent after determining the first PSF network element meets a re-location condition.

A second aspect of the disclosure involves an apparatus, comprising: one or more processors, wherein the one or more processors are configured to: determine, a first processing service function (PSF) network element in a communication system that executing a first sub-task meets a re-location condition, wherein the first sub-task is sub-task within a mission managed by the apparatus, and the first PSF network element is managed by a first task control function (TCF) network element in the communication system; send a re-location request to the first TCF network element, wherein the re-location request instructing the first TCF network element to switch the first sub-task from the first PSF network element to a second PSF network element for execution, wherein the second PSF network element is managed by the first TCF network element.

In some embodiments of the second aspect, the apparatus may send a re-location request to the TCF network element to instructing the TCF network element switch the first sub-task from the first PSF network element (e.g. o-PSF in the description part) to the second PSF network element (e.g. n-PSF in the description part) for execution. That is, if the resource in the communication system is not balance or the resource available for the first PSF network element is not enough to execute the first sub-task or in other seniors, the apparatus may instruct the TCF network element to switch the first sub-task to the second PSF network element for execution. Hence the first sub-task can be executed more effectively and the resources in communication system can be balanced.

In some embodiments of the second aspect, the apparatus may be logic or physical network element with the MM (or other function has similar or same function with the MM) in the description part deployed.

One or more embodiments according to the apparatus in the second aspect, wherein: the re-location request comprising an identifier of the second PSF network element, wherein the second PSF network element is determined by the apparatus based on performance parameter of PSF network elements managed by the first TCF network element.

In those embodiments, the second PSF is determined by the apparatus.

One or more embodiments according to the apparatus in the second aspect, wherein the performance parameter comprises at least one of the following parameters: available communication resource, available computing resource, or a network distance from the first PSF network element.

One or more embodiments according to the apparatus in the second aspect, wherein the one or more processors are further configured to: send, to one or more second TCF network elements before sending the re-location request to the first TCF network element, a task execution(TE) customization request, wherein the one or more second TCF network elements manage one or more fourth PSF network elements executing a third task associated with the first sub-task, and the task execution customize request instructs the one or more second TCF network elements to suspend execution of the third task.

In those embodiments, the apparatus may send TE customization request to the one or more second TCF network elements to instructing the one or more second TCF network elements to suspend execution of the third task associated with the first sub-task, which may avoid the re-location procedure of the first sub-task (or the first PSF network element) affect the execution of the third task.

One or more embodiments according to the apparatus in the second aspect, wherein the task execution customize request further instructs the one or more second TCF network elements to: control the one or more fourth PSF network element to switch a third data forwarding relationship with the first PSF network element to a fourth data forwarding relationship with the second PSF network element, and/or control the one or more fourth PSF network element to resume execution of the third task after suspended for a second duration, and/or customize local configurations of the one or more second TCF network elements.

In those embodiments, the fourth PSF network element may also switch a third data forwarding relationship with the first PSF network element to fourth data forwarding relationship with the second PSF network element. Hence the data which should be transmitted to the first PSF network element may be transmitted to the second PSF network element, and/or the data which should be received from the first PSF network element may be received from the second PSF, which can ensure the execution of the third task. Besides, the fourth PSF network element may resume execution of the third task after suspended for a second duration (e.g. after the first sub-task is switched to the second PSF network element for execution).

One or more embodiments according to the apparatus in the second aspect, wherein: the re-location request instructs the first TCF network element to determine the second PSF network element from PSF network elements managed by the first TCF network element, and switch the first sub-task to the second PSF network element for execution.

In those embodiments, the second PSF network element is determined by the TCF.

One or more embodiments according to the apparatus in the second aspect, wherein the one or more processors are further configured to: receive, from the first TCF network element, a second identifier of the second PSF network element; send, to one or more second TCF network elements managing one or more fourth PSF network elements executing a third task, a task execution customize request, wherein the third task is associated with the first sub-task, and the task execution customize request instructs the one or more second TCF network elements to suspend execution of the third task.

In those embodiments, the apparatus may send task execution customize request to the one or more second TCF network elements (e.g. r-TCF in the description part), hence one or more second TCF network elements may suspend execution of the third task associated with the first sub-task, which may avoid the re-location procedure affect the execution of the third task.

One or more embodiments according to the apparatus in the second aspect, wherein the task execution customize request further instructs the one or more second TCF network elements to: control the corresponding fourth PSF network element switch a third data forwarding relationship with the first PSF network element to a fourth data forwarding relationship with the second PSF network element, and/or control the corresponding fourth PSF network element resume execution of the third task after suspended for a second duration, and/or, customize local configurations of the one or more second TCF network elements.

In those embodiments, the fourth PSF network element may also switch a third data forwarding relationship with the first PSF network element to fourth data forwarding relationship with the second PSF network element. Hence the data which should be transmitted to the first PSF network element may be transmitted to the second PSF network element, and/or the data which should be received from the first PSF network element may be received from the second PSF, which can ensure the execution of the third task. Besides, the fourth PSF network element may resume execution of the third task after suspended for a second duration (e.g. after the first sub-task is switched to the second PSF network element for execution).

One or more embodiments according to the apparatus in the second aspect, wherein the one or more processors are further configured to: receive a re-location request response from the first TCF network element; send, to the one or more second TCF network elements, a resume execution request instructing the one or more second TCF network elements to control the corresponding fourth PSF network element to resume execution of the third task.

In those embodiments, the apparatus may send resume execution request to the one or more second TCF network elements, hence the one or more second TCF network elements may resume execution of the third task, which may improve the execution efficiency of the third task.

One or more embodiments according to the apparatus in the second aspect, wherein the re-location condition comprises at least one of the following conditions: available communication resource of the first PSF network element is less than a first threshold; available computing resource of the first PSF network element is less than a second threshold; determining to execute a load balancing policy on a network entity corresponding to the first PSF network element.

A third aspect of the disclosure involves an apparatus, comprising: one or more processors, wherein the one or more processors are configured to: receive, from a mission management (MM) network element in a communications system, a task execution customize request, send a second PSF customize request to one or more fourth PSF network elements in response to task execution customize request, wherein, the one or more fourth PSF network elements are managed by the apparatus and each of the one or more fourth PSF network elements executes a third task, the second PSF customize request instructs the one or more fourth PSF network elements to suspend execution of the third task.

In some embodiments of the third aspect, the apparatus may control the one or more fourth PSF network elements (e.g. r-PSF managed by r-TCF in the description part) to suspend execution of the third task while the task execution customize request is received, which may avoid the re-location procedure of sub-task (or PSF executing the sub-task) associated with the third task affecting the execution of the third task.

In some embodiments of the third aspect, the apparatus may be logic or physical network element with the related task control function (r-TCF) (or other function has similar or same function with the TCF) in the description part deployed.

One or more embodiments according to the apparatus in the third aspect, wherein the one or more processors are further configured to: customize local configurations of the apparatus before sending the PSF customize request.

One or more embodiments according to the apparatus in the third aspect, wherein the one or more processors are further configured to: receive, from the one or more fourth PSF network elements, a second PSF customize request response, customize local configurations of the apparatus in response to the second PSF customize request response.

One or more embodiments according to the apparatus in the third aspect, wherein the one or more processors are further configured to: receive, from the MM network element, a resume execution request; send, to the one or more fourth PSF network elements, a resume request instructing the one or more fourth PSF network elements resume execution of the third task.

In those embodiments, the apparatus may send a resume request to the one or more fourth PSF network elements while the resume execution request is received, hence the one or more fourth PSF network elements may resume execution of the third task, which may improve the execution efficiency of the third task.

One or more embodiments according to the apparatus in the third aspect, wherein: the second PSF customize request further instructs the one or more fourth PSF network elements to: switch a third data forwarding relationship with a first PSF network element to a fourth data forwarding relationship with a second PSF network element, and/or resume execution of the third task after suspended for a second duration.

In those embodiments, the one or more fourth PSF network element may also switch a third data forwarding relationship with the first PSF network element to fourth data forwarding relationship with the second PSF network element. Hence the data which should be transmitted to the first PSF network element may be transmitted to the second PSF network element, and/or the data which should be received from the first PSF network element may be received from the second PSF, which can ensure the execution of the third task. Besides, the fourth PSF network element may resume execution of the third task after suspended for a second duration (e.g. after the first sub-task is switched to the second PSF network element for execution).

A fourth aspect of the disclosure involves a method comprising: receiving, from a mission management (MM) network element in a communications system, a re-location request, wherein the MM network element is configured to manage execution of a first mission, and a first sub-task in a first task of the first mission is executed on a first processing service function (PSF) network element; switching the first sub-task to a second PSF network element for execution in response to the re-location request, wherein the first PSF network element and the second PSF network element are managed by a task control function(TCF) in the communication system.

In some embodiments of the fourth aspect, if the resource in the communication system is not balance or the resource available for the first PSF network element is not enough to execute the first sub-task or in other seniors, the apparatus deployed with the method may switch the first sub-task to the second PSF network element for execution. Hence the first sub-task can be executed more effectively and the resources in communication system can be balanced.

In some embodiments of the fourth aspect, the method may be deployed in logic or physical network element with the task control function (TCF) (or other function has similar or same function with the TCF) in the description part deployed.

One or more embodiments according to the method in the fourth aspect, wherein: the switching the first sub-task to a second PSF network element for execution, comprising: sending, to the first PSF network element, a first synchronization request instructing the first PSF network element to synchronize execution data of the first sub-task to the second PSF network element.

One or more embodiments according to the method in the fourth aspect, the switching the first sub-task to a second PSF network element for execution, comprising: sending, to the second PSF network element, a second synchronization request instructing the second PSF network element to obtain the execution data of the first sub-task from the first PSF network element.

One or more embodiments according to the method in the fourth aspect, wherein: the execution data comprises at least one of the following information: PSF network element information of a PSF network element executing a task associated with the first sub-task; execution progress of the first sub-task; or intermediate data obtained by the first PSF network element by executing the first sub-task.

One or more embodiments according to the method in the fourth aspect, wherein the method further comprising: sending, to the second PSF network element before sending the first synchronization request to the first PSF network element or before sending the second synchronization request to the second PSF network element, a first configuration request instructing the second PSF network element to configure execution parameter.

One or more embodiments according to the method in the fourth aspect, wherein: the execution parameter comprises at least one of the following parameter: session identifier of a connected data session, data forwarding rule, or data synchronization rule.

One or more embodiments according to the method in the fourth aspect, the method further comprising: sending, to one or more third PSF network elements before sending the first configuration request to the second PSF network element, a first PSF execution customize request, wherein, the first PSF network element and the one or more third PSF network elements are managed by the same task control function(TCF) network element, each of the one or more third PSF network elements executes a second task associated with the first sub-task, and first PSF execution customize request instructs the one or more third PSF network elements to suspend execution of the second task.

One or more embodiments according to the method in the fourth aspect, wherein the first PSF execution customize request further instructs the one or more third PSF network elements to: switch a first data forwarding relationship with the first PSF network element to a second data forwarding relationship with the second PSF network element, and/or resume execution of the second task after suspended for a first duration.

One or more embodiments according to the method in the fourth aspect, wherein: the first configuration request is sent to the second PSF network element after receiving a response corresponding to the first customize request.

One or more embodiments according to the method in the fourth aspect, wherein the method further comprising: receiving, from the first PSF network element and/or the second PSF network element, a synchronization response; sending, to the MM network element in response to the synchronization response, a re-location response instructing the MM network element to resume execution of a third task; wherein the third task was suspended before the first sub-task is switched to the second PSF network element for execution, and the third task is associated with the first sub-task.

One or more embodiments according to the method in the fourth aspect, wherein: the method further comprising: receiving, from the first PSF network element and/or the second PSF network element, a synchronization response; sending, to the one or more third PSF network elements, a resume execution request instructing the one or more third PSF network elements to resume execution of the second task.

One or more embodiments according to the method in the fourth aspect, wherein: the first PSF network element and the second PSF network element are managed by a first TCF network element, the second PSF network element is determined based on performance parameter of PSF network elements managed by the first TCF network element, and the performance parameter comprises at least one of the following parameters: available communication resource, available computing resource, or network location.

One or more embodiments according to the method in the fourth aspect, wherein the re-location request comprises a first identifier of the first PSF network element and a second identifier of the second PSF network element.

One or more embodiments according to the method in the fourth aspect, wherein the re-location request is sent after determining the first PSF network element meets a re-location condition.

The detail explanation and beneficial effects of the fourth aspect may refer to the first aspect.

A fifth aspect of the disclosure involves a method comprising: determining, a first processing service function (PSF) network element in a communication system that executing a first sub-task meets a re-location condition, wherein the first sub-task is sub-task within a mission managed by a mission management (MM) network element, and the first PSF network element is managed by a first task control function (TCF) network element in the communication system; sending a re-location request to the first TCF network element, wherein the re-location request instructing the first TCF network element to switch the first sub-task from the first PSF network element to a second PSF network element for execution, wherein the second PSF network element is managed by the first TCF network element.

In some embodiments of the fifth aspect, a re-location request may be sent to the TCF network element to instructing the TCF network element switch the first sub-task from the first PSF network element (e.g. o-PSF in the description part) to the second PSF network element (e.g. n-PSF in the description part) for execution. That is, if the resource in the communication system is not balance or the resource available for the first PSF network element is not enough to execute the first sub-task or in other seniors, the TCF network element may switch the first sub-task to the second PSF network element for execution. Hence the first sub-task can be executed more effectively and the resources in communication system can be balanced.

In some embodiments of the fifth aspect, the method may be deployed by a logic or physical network element with the MM (or other function has similar or same function with the MM) in the description part deployed.

One or more embodiments according to the method in the fifth aspect, wherein: the re-location request comprising an identifier of the second PSF network element, wherein the second PSF network element is determined by the mission management (MM) network element based on performance parameter of PSF network elements managed by the first TCF network element.

One or more embodiments according to the method in the fifth aspect, wherein the performance parameter comprises at least one of the following parameters: available communication resource, available computing resource, or a network distance from the first PSF network element.

One or more embodiments according to the method in the fifth aspect, wherein the method further comprising: sending, to one or more second TCF network elements before sending the re-location request to the first TCF network element, a task execution(TE) customization request, wherein the one or more second TCF network elements manage one or more fourth PSF network elements executing a third task associated with the first sub-task, and the task execution customize request instructs the one or more second TCF network elements to suspend execution of the third task.

One or more embodiments according to the method in the fifth aspect, wherein the task execution customize request further instructs the one or more second TCF network elements to: control the one or more fourth PSF network elements to switch a third data forwarding relationship with the first PSF network element to a fourth data forwarding relationship with the second PSF network element, and/or control the one or more fourth PSF network elements to resume execution of the third task after suspended for a second duration, and/or customize local configurations of the one or more second TCF network elements.

One or more embodiments according to the method in the fifth aspect, wherein: the re-location request instructs the first TCF network element to determine the second PSF network element from PSF network elements managed by the first TCF network element, and switch the first sub-task to the second PSF network element for execution.

One or more embodiments according to the method in the fifth aspect, wherein the method further comprising: receiving, from the first TCF network element, a second identifier of the second PSF network element; sending, to one or more second TCF network elements managing one or more fourth PSF network elements executing a third task, a task execution customize request, wherein the third task is associated with the first sub-task, and the task execution customize request instructs the one or more second TCF network elements to suspend execution of the third task.

One or more embodiments according to the method in the fifth aspect, wherein the task execution customize request further instructs the one or more second TCF network elements to: control the corresponding fourth PSF network element switch a third data forwarding relationship with the first PSF network element to a fourth data forwarding relationship with the second PSF network element, and/or control the corresponding fourth PSF network element resume execution of the third task after suspended for a second duration, and/or, customize local configurations of the one or more second TCF network elements.

One or more embodiments according to the method in the fifth aspect, wherein the method further comprising: receiving a re-location request response from the first TCF network element; sending, to the one or more second TCF network elements, a resume execution request instructing the one or more second TCF network elements to control the corresponding fourth PSF network element to resume execution of the third task.

One or more embodiments according to the method in the fifth aspect, wherein the re-location condition comprises at least one of the following conditions: available communication resource of the first PSF network element is less than a first threshold; available computing resource of the first PSF network element is less than a second threshold; determining to execute a load balancing policy on a network entity corresponding to the first PSF network element.

The detail explanation and beneficial effects of the fifth aspect may refer to the second aspect.

A sixth aspect of the disclosure involves a method comprising: receiving, from a mission management (MM) network element in a communications system, a task execution customize request, sending a second PSF customize request to one or more fourth PSF network elements in response to the task execution customize request, wherein, the one or more fourth PSF network elements are managed by the a third task control function(TCF) network element and each of the one or more fourth PSF network elements executes a third task, the second PSF customize request instructs the one or more fourth PSF network elements to suspend execution of the third task.

One or more embodiments according to the method in the sixth aspect, wherein the method further comprising: customizing local configurations of the method before sending the second PSF customize request.

One or more embodiments according to the method in the sixth aspect, wherein the method further comprising: receiving, from the one or more fourth PSF network elements, a second PSF customize request response; customizing local configurations of the method in response to the second PSF customize request response.

One or more embodiments according to the method in the sixth aspect, wherein method further comprising: receiving, from the MM network element, a resume execution request; sending, to the one or more fourth PSF network elements, a resume request instructing the one or more fourth PSF network elements to resume execution of the third task.

One or more embodiments according to the method in the sixth aspect, wherein: the second PSF customize request further instructs the one or more fourth PSF network elements to: switch a third data forwarding relationship with a first PSF network element to a fourth data forwarding relationship with a second PSF network element, and/or resume execution of the third task after suspended for a second duration.

The detail explanation and beneficial effects of the sixth aspect may refer to the third aspect.

A seventh aspect of the disclosure involves a computer program comprising programming for execution by a processor, the programming including instructions to perform any one of methods involved in the fourth aspect, the fifth aspect and the sixth aspect.

An eighth aspect of the disclosure involves a non-transitory computer readable medium storing programming for execution by a processor, the programming including instructions to perform any one of methods involved in the fourth aspect, the fifth aspect and the sixth aspect.

A ninth aspect of the disclosure involves a communications method applied to a communication system, wherein: the communication system comprises: a MM network element, a first TCF network element managed by the MM network element, a first PSF network element and a second PSF network element managed by the first TCF network element, the first PSF network element executes a first sub-task in a first task of a first mission managed by the MM network element; and the method comprising: determining the first PSF network element meets a re-location condition and sending a re-location request to the first TCF network element by the MM network element; switching, by the first TCF network element, the first sub-task to the second PSF network element for execution in response to the re-location request.

One or more embodiments of method in the ninth aspect, wherein the communication system further comprising one or more second TCF network elements managing one or more fourth PSF network elements executing a third task associated with the first sub-task, and the method further comprising: sending, to the one or more send TCF network elements from the MM network element before the first TCF network element switching the first sub-task to the second PSF network element for execution, a task execution customize request; suspending, by the one or more second TCF network elements in response to the task execution customize request, the execution of the third task on the one or more fourth PSF network elements.

One or more embodiments of method in the ninth aspect, wherein the communication system further comprising one or more third PSF network elements executing a second task associated with the first sub-task, and the method further comprising: suspending, by the first TCF network element before switching first sub-task to the second PSF network element for execution, the execution of the second task on the one or more third PSF network elements.

A tenth aspect of the disclosure involves a communications system comprising: any one of apparatus in the first aspect, any one of apparatus in the second aspect, and any one of apparatus in the third aspect.

The detail explanation and beneficial effects of the seventh aspect to the tenth aspect may refer to the first aspect to the sixth aspect.

### BRIEF DESCRIPTION OF THE DRAWINGS

FIG. 1 shows a simplified schematic illustration of a communication system 100 according to some embodiments of the present disclosure.

FIG. 2 shows a detailed example for communication system 100 apparatuses according to some embodiments of the present disclosure.

FIG. 3 shows an example of an apparatus 310 wirelessly communicating with at least one of two apparatuses according to some embodiments of the present disclosure.

FIG. 4 shows units or modules in a device or apparatus according to some embodiments of the present disclosure.

FIG. 5 shows an example of conceptual structure of 6G System according to some embodiments of the present disclosure.

FIG. 6 shows a structure diagram of system performing data processing service function re-location according to some embodiments of the present disclosure.

FIG. 7A shows a diagram of mission M1 according to some embodiments of the present disclosure.

FIG. 7B shows an execution diagram of mission M1 by the structure of FIG. 6 according to some embodiments of the present disclosure.

FIG. 7C shows an execution diagram of mission M1 by the structure of FIG. 6 after re-location of PSF 023 according to some embodiments of the present disclosure.

FIG. 8 shows a flow diagram of MM enabling PSF re-location procedure according to some embodiments of the present disclosure.

FIG. 9 shows a flow diagram of XaaS enabling PSF re-location procedure according to some embodiments of the present disclosure.

FIG. 10 shows a flow diagram of TE customization procedure according to some embodiments of the present disclosure.

FIG. 11 shows a schematic block diagram of an apparatus according to some embodiments of the present disclosure.

### DETAILED DESCRIPTION OF ILLUSTRATIVE EMBODIMENTS

Illustrative embodiments of the present disclosure include, but are not limited to apparatus, method, and computer readable storage media for communication.

Many new trends can trigger the consideration and design of future wireless networks such as, for example, 6G communication network:

New network infrastructure capability, e.g., cloud natured/friendly infrastructures that are broadly deployed.

New (relative) matured techniques, e.g., artificial intelligence (AI) large scale models, data de-privacy, block chain, etc. that have made significant progresses and significantly impact on the entire society and human life.

New apps and services, e.g., AI services, data (sensing) service, digital world service, etc. that are broadly applied in industry/business and used by individual customers.

More global/open/collaborative operation trend, i.e., a more open and more collaborative operation mode are becoming common practice in many fields.

New expectation and stricter requirements on future networks also drive rethinking and development of new generation of wireless networks. These requirements include privacy and trustworthiness, simplified standardization, rapid deployment, etc.

All of the above drives 6G network architecture research work.

In some embodiments, a 6G network architecture (X-centric) may be SBA (X as a service (XaaS) service) based and cloud-native. Requirements to 6G System network architecture design: The 6G network architecture may support new 6G services which could be developed/deployed by 3rd parties, embrace more open ecosystem to open door to technical capable 3rd parties, and enable better trustworthiness management. Embodiments of this disclosure is about solutions to enable above requirements.

In some embodiments, XaaS refers to X as a service. SBA refers to XaaS.

To assist in understanding the present disclosure, examples of wireless communication systems and devices are described below.

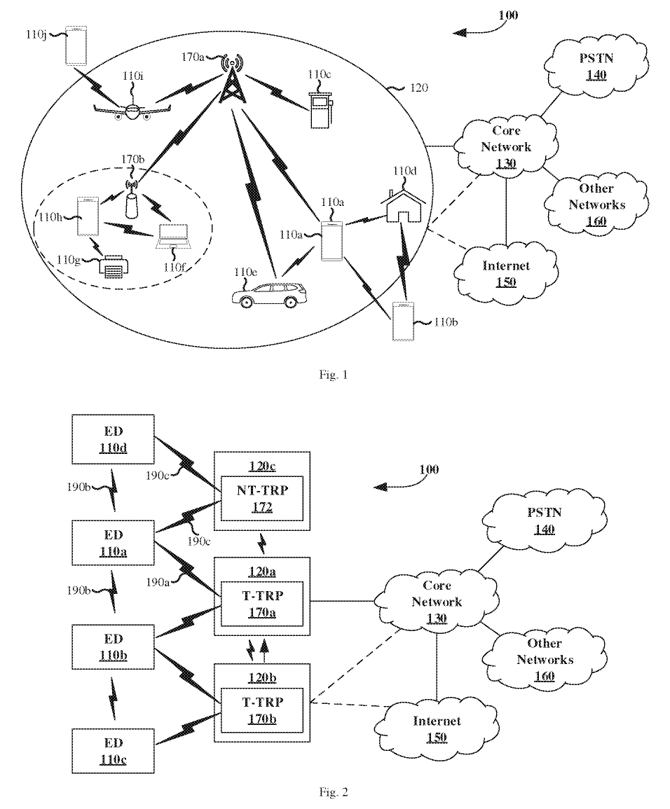

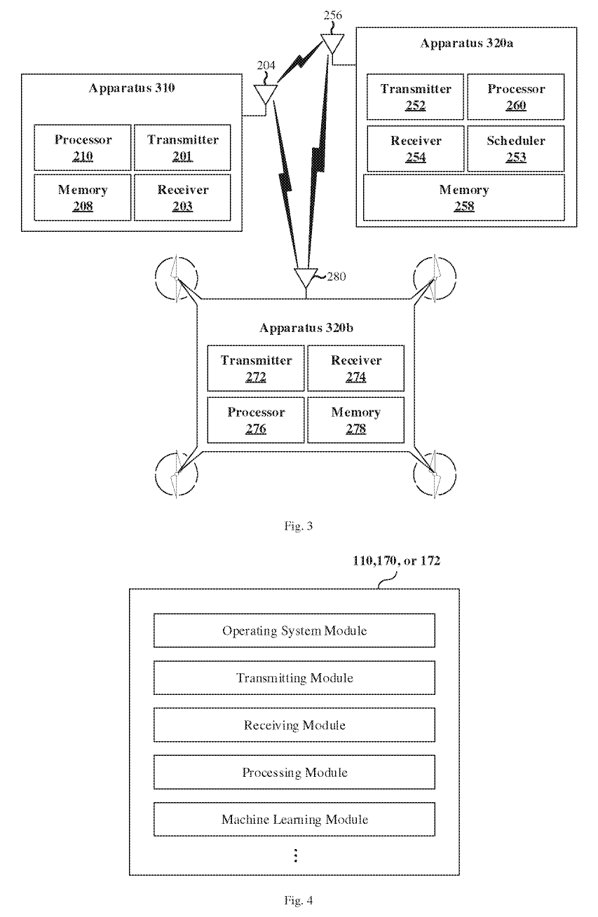

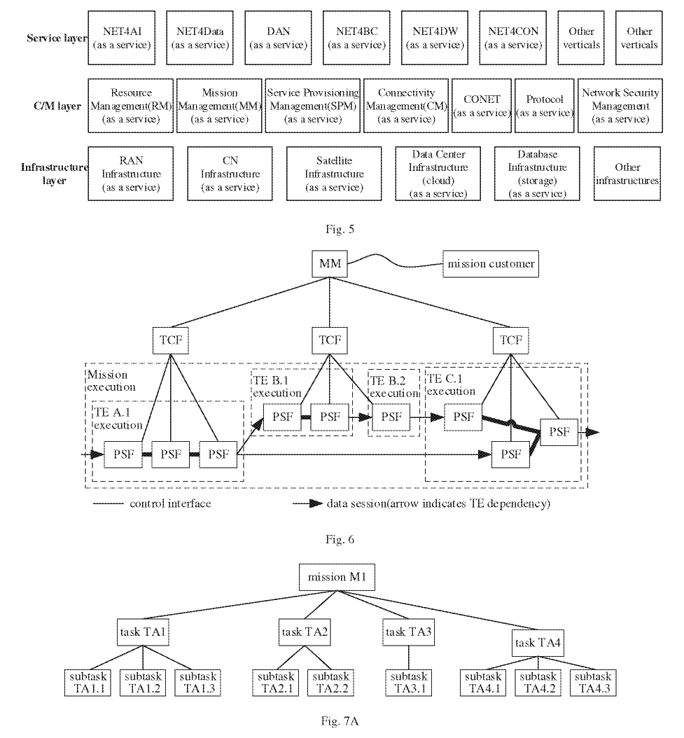

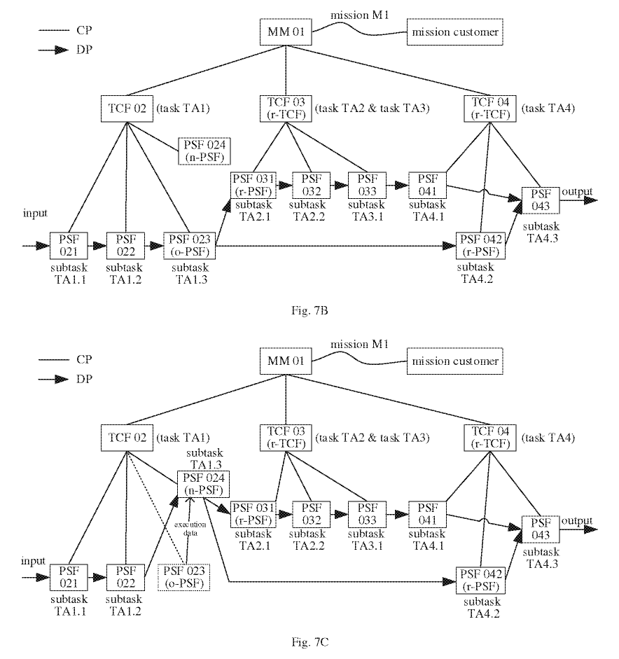

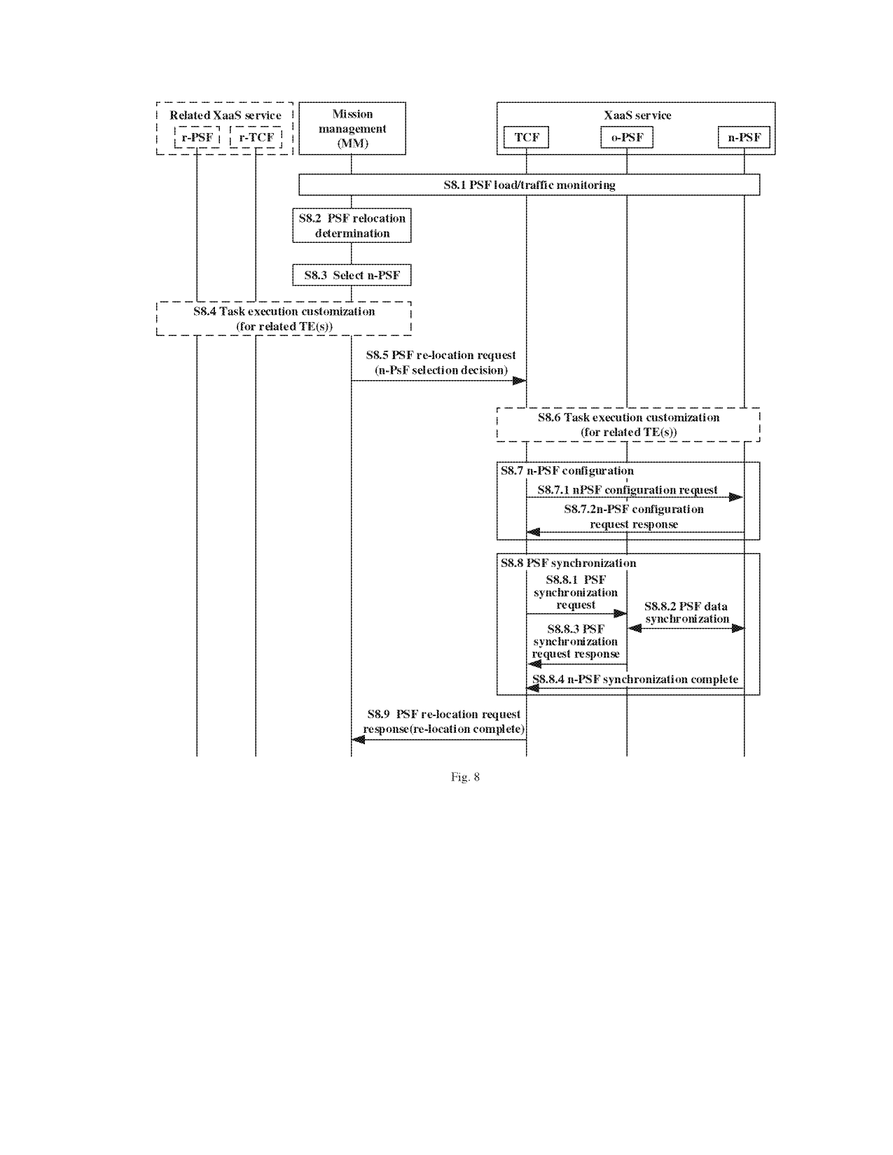

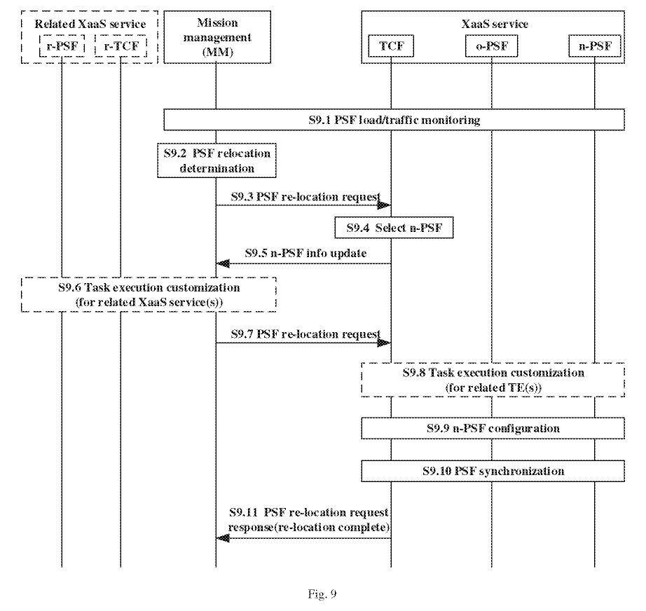

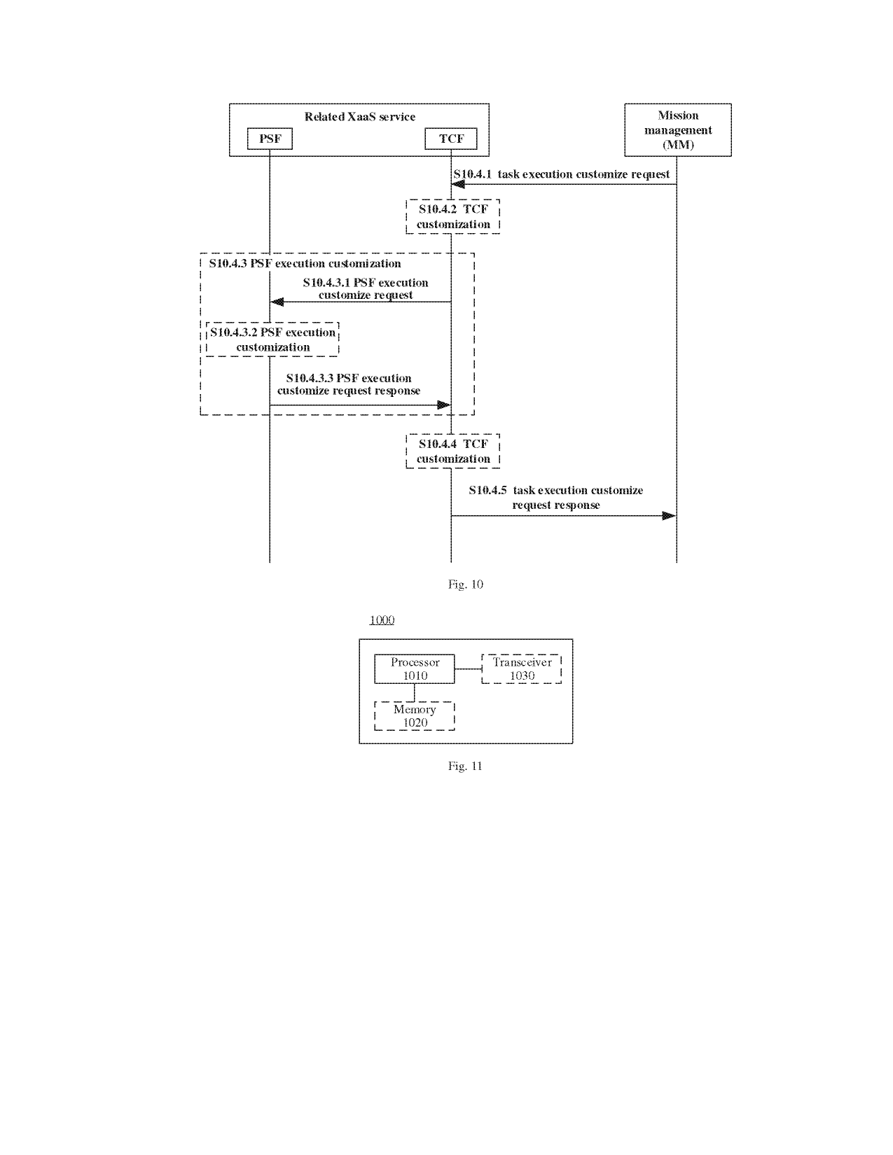

Referring to FIG. 1, as an illustrative example without limitation, a simplified schematic illustration of a communication system is provided. The communication system 100 (which may be a wireless system) comprises a radio access network 120. The radio access network (RAN) 120 may be a next generation (e.g. sixth generation (6G) or later) radio access network, or a legacy (e.g. 5G, 4G, 3G or 2nd generation (2G)) radio access network. One or more communication electronic device (ED) 110a, 110b, 110c, 110d, 110e, 110f, 110g, 110h, 110i, 110j (generically referred to as 110) may be interconnected to one another or connected to one or more network nodes (170a, 170b, generically referred to as 170) in the radio access network 120. A core network 130 may be a part of the communication system and may be dependent or independent of the radio access technology used in the communication system 100. The communication system 100 may also comprise a public switched telephone network (PSTN) 140, the internet 150, and other networks 160.

In general, the communication system 100 enables multiple wireless or wired elements to communicate data and other content. The communication system 100 may provide content, such as voice, data, video, and/or text, via broadcast, multicast, groupcast, unicast, etc. And the communication system 100 may provide a wide range of communication services and applications (such as earth monitoring, remote sensing, passive sensing and positioning, navigation and tracking, autonomous delivery and mobility, etc.) The services and/or applications may be mobile broadband (MBB) services, ultra-reliable low-latency communication (URLLC) services, or machine type communication (MTC) services.

The communication system 100 may operate by sharing resources, such as carrier spectrum bandwidth, between its constituent elements.

FIG. 2 illustrates more detailed example for communication system 100.

The communication system 100 may include a terrestrial communication system and/or a non-terrestrial communication system. The communication system 100 may provide a high degree of availability and robustness through a joint operation of a terrestrial communication system and a non-terrestrial communication system. For example, integrating a non-terrestrial communication system (or components thereof) into a terrestrial communication system can result in what may be considered a heterogeneous network comprising multiple layers. The heterogeneous network may achieve better overall performance through efficient multi-link joint operation, more flexible functionality sharing, and faster physical layer link switching between terrestrial networks and non- terrestrial networks.

The terrestrial communication system and the non-terrestrial communication system could be considered sub-systems of the communication system.

Same as in the example shown in FIG. 1 , in the example shown in FIG. 2, the communication system 100 may include ED 110a, 110b, 110c, 110d (generically referred to as ED 110), and RAN 120a, 120b. In addition, the communication system 100 may also include a non-terrestrial communication network 120c. The communication system 100 may also include one or more of a core network 130, a public switched telephone network (PSTN) 140, the Internet 150, and other networks 160. The RANs 120a, 120b include respective RAN nodes such as base stations (BSs) 170a, 170b, which may be generically referred to as terrestrial transmit and receive points (T-TRPs) 170a, 170b. In one implementation, the non-terrestrial communication network 120c includes a RAN node such as an access node (or base station) 172, which may be generically referred to as a non-terrestrial transmit and receive point (NT-TRP) 172. As may be surmised on the basis of similarity in reference numerals, the non-terrestrial communication network 120c may be considered to be a radio access network, with operational aspects in common with the RANs 120a, 120b. In another implementations, the non-terrestrial communication network 120c may include at least one non-terrestrial network (NTN) device and at least one corresponding terrestrial network device, wherein the at least one non-terrestrial network device works as a transport layer device and the at least one corresponding terrestrial network device works as a RAN node, which communicates with the ED via the non-terrestrial network device. In addition, there may be a NTN gateway in the ground (i.e., referred as a terrestrial network device) also as a transport layer device to communication with both the NTN device, and the RAN node communicates with the ED via the NTN device and the NTN gateway. In some implementations, the NTN gateway and the RAN node may be located in the same device.

Any ED 110 may be alternatively or additionally configured to interface, access, or communicate with any T-TRP 170a,170b and NT-TRP 172, the Internet 150, the core network 130, the PSTN 140, the other networks 160, or any combination of the preceding. In some examples, ED 110a may communicate an uplink (UL) and/or downlink (DL) transmission over a terrestrial air interface 190a with T-TRP 170a. In some examples, the EDs 110a, 110b, 110c, and 110d may also communicate directly with one another via one or more sidelink (SL) air interfaces 190b. In some examples, ED 110d may communicate an uplink and/or downlink transmission over a non-terrestrial air interface 190c with NT-TRP 172.

An air interface (e.g., 190a, 190b, 190c) generally includes a number of components and associated parameters that collectively specify how a transmission is to be sent and/or received over a wireless communications link between two or more communicating devices. For example, an air interface may include one or more components defining the waveform(s), frame structure(s), multiple access scheme(s), protocol(s), coding scheme(s) and/or modulation scheme(s) for conveying information (e.g., data) over a wireless communications link. The wireless communications link may support a link (e.g., a “Uu” link) between a radio access network (e.g., RAN 120) and user equipment (e.g., ED 110) and/or the wireless communications link may support a link (e.g., a “LS”) between device (e.g., ED 110a) and device (e.g., ED 110b), such as between two user equipments, and/or the wireless communications link may support a link between a non-terrestrial (NT)-communication network (e.g, RAN 120c) and user equipment (e.g., ED 110d). The following are some examples for the above components.

A waveform component may specify a shape and form of a signal being transmitted. Waveform options may include orthogonal multiple access waveforms and non-orthogonal multiple access waveforms. Non-limiting examples of such waveform options include orthogonal frequency division multiplexing (OFDM), discrete Fourier transform spread OFDM (DFT-OFDM), filtered OFDM (f-OFDM), time windowing OFDM, filter bank multicarrier (FBMC), universal filtered multicarrier (UFMC), generalized frequency division multiplexing (GFDM), wavelet packet modulation (WPM), faster than Nyquist (FTN) waveform and low peak to average power ratio waveform (low peak-to-average power ratio (PAPR) WF).

A frame structure component may specify a configuration of a frame or group of frames. The frame structure component may indicate one or more of a time, frequency, pilot signature, code, subcarrier spacing, cyclic prefix length or other parameter of the frame or group of frames. More details of frame structure will be discussed hereinafter.

A multiple access scheme component may specify multiple access technique options, including technologies defining how communicating devices share a common physical channel, such as: code division multiple access (CDMA), space division multiple access (SDMA), time division multiple access (TDMA), frequency division multiple access (FDMA), orthogonal FDMA (OFDMA), single-carrier FDMA (SC-FDMA) which is also known as discrete Fourier transform spread OFDMA(DFT-s-OFDMA), low density signature multicarrier CDMA (LDS-MC-CDMA); non-orthogonal multiple access (NOMA); pattern division multiple access (PDMA); lattice partition multiple access (LPMA); resource spread multiple access (RSMA); and sparse code multiple access (SCMA). Furthermore, multiple access technique options may include: scheduled access vs. non-scheduled access, also known as grant-free access; non-orthogonal multiple access vs. orthogonal multiple access, e.g., via a dedicated channel resource (e.g., no sharing between multiple communicating devices); contention-based shared channel resources vs. non-contention-based shared channel resources; and cognitive radio-based access. The air interfaces 190a and 190b may utilize other higher dimension signal spaces, which may involve a combination of orthogonal and/or non-orthogonal dimensions.

A coding and modulation component may specify how information being transmitted may be encoded/decoded and modulated/demodulated for transmission/reception purposes. Coding may refer to methods of error detection and forward error correction. Non-limiting examples of coding options include turbo trellis codes, turbo product codes, fountain codes, low-density parity check codes and polar codes. Modulation may refer, simply, to the constellation (including, for example, the modulation technique and order), or more specifically to various types of advanced modulation methods such as hierarchical modulation and low PAPR modulation.

The air interfaces 190a and 190b may use similar communication technology, such as any suitable radio access technology.

The non-terrestrial air interface 190c can enable communication between the ED 110d and one or multiple NT-TRPs 172 via a wireless link or simply a link. For some examples, the link is a dedicated connection for unicast transmission, a connection for broadcast transmission, or a connection between a group of EDs 110 and one or multiple NT-TRPs 172 for multicast transmission.

The RANs 120a and 120b are in communication with the core network 130 to provide the EDs 110a110b, and 110c with various services such as voice, data, and other services. The RANs 120a and 120b and/or the core network 130 may be in direct or indirect communication with one or more other RANs (not shown), which may or may not be directly served by core network 130, and may or may not employ the same radio access technology as RAN 120a, RAN 120b or both. The core network 130 may also serve as a gateway access between (i) the RANs 120a and 120b or EDs 110a110b, and 110c or both, and (ii) other networks (such as the PSTN 140, the Internet 150, and the other networks 160). In addition, some or all of the EDs 110a 110b, and 110c may include functionality for communicating with different wireless networks over different wireless links using different wireless technologies and/or protocols. Instead of wireless communication (or in addition thereto), the EDs 110a110b, and 110c may communicate via wired communication channels to a service provider or switch (not shown), and to the Internet 150. PSTN 140 may include circuit switched telephone networks for providing plain old telephone service (POTS). Internet 150 may include a network of computers and subnets (intranets) or both, and incorporate protocols, such as internet protocol (IP), transmission control protocol (TCP), user datagram protocol (UDP). EDs 110a 110b, and 110c may be multimode devices capable of operation according to multiple radio access technologies, and incorporate multiple transceivers necessary to support such.

In addition, the communication system 100 may comprising a sensing agent (not shown in the figure) to manage the sensed data from ED110 and or the T-TRP 170 and/or NT-TRP 172. In one implementation, the sensing agent is located in the T-TRP 170 and/or NT-TRP 172. In another implementation, the sensing agent is a separate node which has interface to communicate with the core network 130 and/or the RAN 120 (e.g., the T-TRP 170 and/or NT-TRP 172).

FIG. 3 illustrates example of an Apparatus 310 wirelessly communicating with at least one of two apparatuses (e.g., Apparatus 320a and Apparatus 320b, referred as Apparatus 320) in a communication system, e.g., the communication system 100, according to one embodiment. The Apparatus 310 may be a UE (e.g., ED 110 in FIG. 2). The Apparatus 320a may be a terrestrial network device (e.g., T-TRP 170 as shown in FIG. 2), and Apparatus 320b may be a non-terrestrial network device (e.g., NT-TRP 172 as shown in FIG. 2). However, this is not necessary. For example, Apparatus 320a may be a NT-TRP, and 320b may be a T-TRP, both Apparatus 320a and 320b may be T-TRPs or NT-TRPs, according to present disclosure. In the following, the ED 110 as an example of the Apparatus 310 is described, and T-TRP 170 as an example of Apparatus 320a is described, and NT-TRP 172 as an example of Apparatus 320a is described. Although only one Apparatus 310, one Apparatus 320a and one Apparatus 320b. In some embodiments, the number of Apparatus 310 (e.g. ED 110) could be one or more, and the number of Apparatus 320a and/or 320b could be one or more. For example, one ED110 may be served by only one T-TRP 170 (or one NT-TRP172), by more than one T-TRP 170, by more than one NT-TRP 172, or by one or more T-TRP 170 and one or more NT-TRP172.

The ED 110 is used to connect persons, objects, machines, etc. The ED 110 may be widely used in various scenarios including, for example, cellular communications, device-to-device (D2D), vehicle to everything (V2X), peer-to-peer (P2P), machine-to-machine (M2M), MTC, internet of things (IoT), virtual reality (VR), augmented reality (AR), mixed reality (MR), metaverse, digital twin, industrial control, self-driving, remote medical, smart grid, smart furniture, smart office, smart wearable, smart transportation, smart city, drones, robots, remote sensing, passive sensing, positioning, navigation and tracking, autonomous delivery and mobility, etc.

Each ED 110 represents any suitable end user device for wireless operation and may include such devices (or may be referred to but not limited to) as a user equipment/device (UE), a wireless transmit/receive unit (WTRU), a mobile station, a fixed or mobile subscriber unit, a cellular telephone, a station (STA), a MTC device, a personal digital assistant (PDA), a smartphone, a laptop, a computer, a tablet, a wireless sensor, a consumer electronics device, a smart book, a vehicle, a car, a truck, a bus, a train, or an IoT device, wearable devices (such as a watch, a pair of glasses, head mounted equipment, etc.), an industrial device, or an apparatus in (e.g. communication module, modem, or chip) or comprising the forgoing devices, among other possibilities. Future generation EDs 110 may be referred to using other terms. The base station 170a and 170b is a T-TRP and will hereafter be referred to as T-TRP 170. Also shown in FIG. 2, a non-terrestrial (NT) device will hereafter be referred to as NT-TRP 172. Each ED 110 connected to T-TRP 170 and/or NT-TRP 172 can be dynamically or semi-statically turned-on (i.e., established, activated, or enabled), turned-off (i.e., released, deactivated, or disabled) and/or configured in response to one of more of: connection availability and connection necessity.

In some embodiments, the structure of ED 110 may refer to the Apparatus 310 in FIG. 3.

As shown in FIG. 3, the ED 110 include at least one processor 210. Only one processor 210 is illustrated to avoid congestion in the drawing. The ED 110 may further include a transmitter 201 and a receiver 203 coupled to one or more antennas 204. Only one antenna 204 is illustrated to avoid congestion in the drawing. One, some, or all of the antennas 204 may alternatively be panels. The transmitter 201 and the receiver 203 may be integrated, e.g. as a transceiver. The transceiver is configured to modulate data or other content for transmission by at least one antenna 204 or network interface controller (NIC). The transceiver is also configured to demodulate data or other content received by the at least one antenna 204. Each transceiver includes any suitable structure for generating signals for wireless or wired transmission and/or processing signals received wirelessly or by wire. Each antenna 204 includes any suitable structure for transmitting and/or receiving wireless or wired signals. The ED 110 may include at least one memory 208. Only the transmitter 201, receiver 203, processor 210, memory 208, and antenna 204 is illustrated for simplicity, but the ED 110 may include one or more other components. The memory 208 stores instructions. The memory 208 may also stores data used, generated, or collected by the ED 110. For example, the memory 208 could store software instructions or modules configured to implement some or all of the functionality and/or embodiments described herein and that are executed by one or more processing unit(s) (e.g., a processor 210). Each memory 208 includes any suitable volatile and/or non-volatile storage and retrieval device(s). Any suitable type of memory may be used, such as random access memory (RAM), read only memory (ROM), hard disk, optical disc, subscriber identity module (SIM) card, memory stick, secure digital (SD) memory card, on-processor cache, and the like.

The ED 110 may further include one or more input/output devices (not shown) or interfaces (such as a wired interface to the Internet 150 in FIG. 1). The input/output devices or interfaces permit interaction with a user or other devices in the network. Each input/output device or interface includes any suitable structure for providing information to or receiving information from a user, and/or for network interface communications. Suitable structures include, for example, a speaker, microphone, keypad, keyboard, display, touch screen, etc.

The processor 210 performs (or controlling the ED110 to perform) operations described herein as being performed by the ED110. As illustrated below and elsewhere in the present disclosure. For example, the processor 210 performs or controls the ED110 to perform receiving transport blocks (TBs), using a resource for decoding of one of the received TBs, releasing the resource for decoding of another of the received TBs, and/or receiving configuration information configuring a resource. In details, the operation may include those operations related to preparing a transmission for uplink transmission to the NT-TRP 172 and/or the T-TRP 170; those operations related to processing downlink transmissions received from the NT-TRP 172 and/or the T-TRP 170; and those operations related to processing sidelink transmission to and from another ED 110. Processing operations related to preparing a transmission for uplink transmission may include operations such as encoding, modulating, transmit beamforming, and generating symbols for transmission. Processing operations related to processing downlink transmissions may include operations such as receive beamforming, demodulating and decoding received symbols. Processing operations related to processing sidelink transmissions may include operations such as transmit/receive beamforming, modulating/demodulating and encoding/decoding symbols. Depending upon the embodiment, a downlink transmission may be received by the receiver 203, possibly using receive beamforming, and the processor 210 may extract signaling from the downlink transmission (e.g. by detecting and/or decoding the signaling). An example of signaling may be a reference signal transmitted by the NT-TRP 172 and/or by the T-TRP 170. In some embodiments, the processor 210 implements the transmit beamforming and/or the receive beamforming based on the indication of beam direction, e.g. beam angle information (BAI), received from the T-TRP 170. In some embodiments, the processor 210 may perform operations relating to network access (e.g. initial access) and/or downlink synchronization, such as operations relating to detecting a synchronization sequence, decoding and obtaining the system information, etc. In some embodiments, the processor 210 may perform channel estimation, e.g. using a reference signal received from the NT-TRP 172 and/or from the T-TRP 170.

Although not illustrated, the processor 210 may form part of the transmitter 201 and/or part of the receiver 203. Although not illustrated, the memory 208 may form part of the processor 210.

The processor 210, the processing components of the transmitter 201, and the processing components of the receiver 203 may each be implemented by the same or different one or more processors that are configured to execute instructions stored in a memory (e.g. in the memory 208). Alternatively, some or all of the processor 210, the processing components of the transmitter 201, and the processing components of the receiver 203 may each be implemented using dedicated circuitry, such as a programmed field-programmable gate array (FPGA), an application-specific integrated circuit (ASIC), or a hardware accelerator such as a graphics processing unit (GPU) or an artificial intelligence (AI) accelerator.

In some implementations, the ED 110 may be an apparatus (also called component) for example, communication module, modem, chip, or chipset, it includes at least one processor 210, and an interface or at least one pin. In this scenario, the transmitter 201 and receiver 203 may be replaced by the interface or at least one pin, wherein the interface or at least one pin is to connect the apparatus (e.g., chip) and other apparatus (e.g., chip, memory, or bus). Accordingly, the transmitting information to the NT-TRP 172 and/or the T-TRP 170 and/or another ED 110 may be referred as transmitting information to the interface or at least one pin, or as transmitting information to the NT-TRP 172 and/or the T-TRP 170 and/or another ED 110 via the interface or at least one pin, and receiving information from the NT-TRP 172 and/or the T-TRP 170 and/or another ED 110 may be referred as receiving information from the interface or at least one pin, or as receiving information from the NT-TRP 172 and/or the T-TRP 170 and/or another ED 110 via the interface or at least one pin. The information may include control signaling and/or data. For other nodes/entities in this disclosure, similar rule applies.

In some embodiments, the structure of T-TRP 170 may refer to the Apparatus 320a in FIG. 3.

As shown in FIG. 3, the T-TRP 170 include at least one processor 260. Only one processor 260 is illustrated to avoid congestion in the drawing. The T-TRP 170 may further include at least one transmitter 252 and at least one receiver 254 coupled to one or more antennas 256. Only one antenna 256 is illustrated to avoid congestion in the drawing. One, some, or all of the antennas 256 may alternatively be panels. The transmitter 252 and the receiver 254 may be integrated as a transceiver. The T-TRP 170 may further include at least one memory 258. The T-TRP 170 may further include scheduler 253. Only the transmitter 252, receiver 254, processor 260, memory 258, antenna 256 and scheduler 253 are illustrated for simplicity, but the T-TRP may include one or more other components.

The T-TRP 170 may be known by other names in some implementations, such as a base station, a base transceiver station (BTS), a radio base station, a network node, a network device, a device on the network side, a transmit/receive node, a Node B, an evolved NodeB (eNodeB or eNB), a Home eNodeB, a next generation NodeB (gNB), a transmission point (TP), a site controller, an access point (AP), a wireless router, a relay station, a terrestrial node, a terrestrial network device, a terrestrial base station, a base band unit (BBU), a remote radio unit (RRU), an active antenna unit (AAU), a remote radio head (RRH), a central unit (CU), a distributed unit (DU), a positioning node, among other possibilities. The T-TRP 170 may be a macro base station (BS), a pico BS, a relay node, a donor node, or the like, or combinations thereof. The T-TRP 170 may refer to the forgoing devices or refer to apparatus (e.g. a communication module, a modem, or a chip) in the forgoing devices.

In some embodiments, the parts of the T-TRP 170 may be distributed. For example, some of the modules of the T-TRP 170 may be located remote from the equipment that houses the antennas 256 for the T-TRP 170, and may be coupled to the equipment that houses the antennas 256 over a communication link (not shown) sometimes known as front haul, such as common public radio interface (CPRI). Therefore, in some embodiments, the term T-TRP 170 may also refer to modules on the network side that perform processing operations, such as determining the location of the ED 110, resource allocation (scheduling), message generation, and encoding/decoding, and that are not necessarily part of the equipment that houses the antennas 256 of the T-TRP 170. The modules may also be coupled to other T-TRPs. In some embodiments, the T-TRP 170 may actually be a plurality of T-TRPs that are operating together to serve the ED 110, e.g. through the use of coordinated multipoint transmissions.

The processor 260 performs operations including those related to: preparing a transmission for downlink transmission to the ED 110, processing an uplink transmission received from the ED 110, preparing a transmission for backhaul transmission to the T-TRP 170 and/or NT-TRP 172, and processing a transmission received over backhaul from the T-TRP 170 and/or NT-TRP 172. Processing operations related to preparing a transmission for downlink or backhaul transmission may include operations such as encoding, modulating, precoding (e.g. multiple input multiple output (MIMO) precoding), transmit beamforming, and generating symbols for transmission. Processing operations related to processing received transmissions in the uplink or over backhaul may include operations such as receive beamforming, demodulating received symbols, and decoding received symbols. The processor 260 may also perform operations relating to network access (e.g. initial access) and/or downlink synchronization, such as generating the content of synchronization signal blocks (SSBs), generating the system information, etc. In some embodiments, the processor 260 also generates an indication of beam direction, e.g. BAI, which may be scheduled for transmission by a scheduler 253. The processor 260 performs other network-side processing operations described herein, such as determining the location of the ED 110, determining where to deploy the NT-TRP 172, etc. In some embodiments, the processor 260 may generate signaling, e.g. to configure one or more parameters of the ED 110 and/or one or more parameters of the NT-TRP 172. Any signaling generated by the processor 260 is sent by the transmitter 252.

The scheduler 253 may be coupled to the processor 260 or integrated in the processor 260. The scheduler 253 may be included within or operated separately from the T-TRP 170. The scheduler 253 may schedule uplink, downlink, sidelink, and/or backhaul transmissions, including issuing scheduling grants and/or configuring scheduling-free (e.g., “configured grant”) resources.

The memory 258 is configured to store information, and optionally data. The memory 258 stores instructions and data used, generated, or collected by the T-TRP 170. For example, the memory 258 could store software instructions or modules configured to implement some or all of the functionality and/or embodiments described herein and that are executed by the processor 260.

Although not illustrated, the processor 260 may form part of the transmitter 252 and/or part of the receiver 254. Also, although not illustrated, the processor 260 may implement the scheduler 253. Although not illustrated, the memory 258 may form part of the processor 260.

The processor 260, the scheduler 253, the processing components of the transmitter 252, and the processing components of the receiver 254 may each be implemented by the same or different one or more processors that are configured to execute instructions stored in a memory, e.g. in the memory 258. Alternatively, some or all of the processor 260, the scheduler 253, the processing components of the transmitter 252, and the processing components of the receiver 254 may be implemented using dedicated circuitry, such as a programmed FPGA, a hardware accelerator (e.g., a GPU or AI accelerator), or an ASIC.

When the T-TRP 170 is an apparatus (also called as component), for example, communication module, modem, chip, or chipset in a device, it includes at least one processor, and an interface or at least one pin. In this scenario, the transmitter 252 and receiver 254 may be replaced by the interface or at least one pin, wherein the interface or at least one pin is to connect the apparatus (e.g., chip) and other apparatus (e.g., chip, memory, or bus). Accordingly, the transmitting information to the NT-TRP 172 and/or the T-TRP 170 and/or ED 110 may be referred as transmitting information to the interface or at least one pin, and receiving information from the NT-TRP 172 and/or the T-TRP 170 and/or ED 110 may be referred as receiving information from the interface or at least one pin. The information may include control signaling and/or data.

Although the NT-TRP 172 is illustrated as a drone only as an example, the NT-TRP 172 may be implemented in any suitable non-terrestrial form, such as satellites and high altitude platforms, including international mobile telecommunication base stations and unmanned aerial vehicles, for example. Also, the NT-TRP 172 may be known by other names in some implementations, such as a non-terrestrial node, a non-terrestrial network device, or a non-terrestrial base station.

As shown in FIG. 3, The T-TRP 170 may further include at least one transmitter 252 and at least one receiver 254 coupled to one or more antennas 256. Only one antenna 256 is illustrated to avoid congestion in the drawing. One, some, or all of the antennas 256 may alternatively be panels. The transmitter 252 and the receiver 254 may be integrated as a transceiver. The T-TRP 170 may further include at least one memory 258. The T-TRP 170 may further include scheduler 253. Only the transmitter 252, receiver 254, processor 260, memory 258, antenna 256 and scheduler 253 are illustrated for simplicity, but the T-TRP may include one or more other components.

In some embodiments, the structure of NT-TRP 172 may refer to the Apparatus 320b in FIG. 3.

As shown in FIG. 3, the NT-TRP 172 include at least one processor 276. Only one processor 276 is illustrated to avoid congestion in the drawing. The NT-TRP 172 may include a transmitter 272 and a receiver 274 coupled to one or more antennas 280. Only one antenna 280 is illustrated to avoid congestion in the drawing. One, some, or all of the antennas may alternatively be panels. The transmitter 272 and the receiver 274 may be integrated as a transceiver. The NT-TRP 172 may further include at least one memory 278. The NT-TRP 172 may further include scheduler. Only the transmitter 272, receiver 274, processor 276, memory 278, antenna 280 are illustrated for simplicity, but the NT-TRP may include one or more other components.

The NT-TRP 172 include a processor 276 for performing operations including those related to: preparing a transmission for downlink transmission to the ED 110, processing an uplink transmission received from the ED 110, preparing a transmission for backhaul transmission to T-TRP 170 and/or another NT-TRP 172, and processing a transmission received over backhaul from the T-TRP 170 and/or another NT-TRP 172. Processing operations related to preparing a transmission for downlink or backhaul transmission may include operations such as encoding, modulating, precoding (e.g. MIMO precoding), transmit beamforming, and generating symbols for transmission. Processing operations related to processing received transmissions in the uplink or over backhaul may include operations such as receive beamforming, demodulating received symbols, and decoding received symbols. In some embodiments, the processor 276 implements the transmit beamforming and/or receive beamforming based on beam direction information (e.g. BAI) received from the T-TRP 170. In some embodiments, the processor 276 may generate signaling, e.g. to configure one or more parameters of the ED 110. In some embodiments, the NT-TRP 172 implements physical layer processing, but does not implement higher layer functions such as functions at the medium access control (MAC) or radio link control (RLC) layer. As this is only an example, more generally, the NT-TRP 172 may implement higher layer functions in addition to physical layer processing.

The memory 278 is configured to store information and optionally data. The memory 258 stores instructions and data used, generated, or collected by the NT-TRP 172. For example, the memory 278 could store software instructions or modules configured to implement some or all of the functionality and/or embodiments described herein and that are executed by the processor 276.

Although not illustrated, the processor 276 may form part of the transmitter 272 and/or part of the receiver 274. Although not illustrated, the memory 278 may form part of the processor 276.

The processor 276, the processing components of the transmitter 272, and the processing components of the receiver 274 may each be implemented by the same or different one or more processors that are configured to execute instructions stored in a memory, e.g. in the memory 278. Alternatively, some or all of the processor 276, the processing components of the transmitter 272, and the processing components of the receiver 274 may be implemented using dedicated circuitry, such as a programmed FPGA, a hardware accelerator (e.g., a GPU or AI accelerator), or an ASIC. In some embodiments, the NT-TRP 172 may actually be a plurality of NT-TRPs that are operating together to serve the ED 110, e.g. through coordinated multipoint transmissions.

When the NT-TRP 172 is an apparatus (e.g. communication module, modem, chip, or chipset) in a device, it includes at least one processor, and an interface or at least one pin. In this scenario, the transmitter 272 and receiver 257 may be replaced by the interface or at least one pin, wherein the interface or at least one pin is to connect the apparatus (e.g., chip) and other apparatus (e.g., chip, memory, or bus). Accordingly, the transmitting information to the T-TRP 170 and/or another NT-TRP 172 and/or ED 110 may be referred as transmitting information to the interface or at least one pin, and receiving information from the T-TRP 170 and/or another NT-TRP 172 and/or ED 110 may be referred as receiving information from the interface or at least one pin. The information may include control signaling and/or data.

Note that “TRP”, as used herein, may refer to a T-TRP or a NT-TRP. A T-TRP may alternatively be called a terrestrial network TRP (“TN TRP”) and a NT-TRP may alternatively be called a non-terrestrial network TRP (“NTN TRP”).The T-TRP 170, the NT-TRP 172, and/or the ED 110 may include other components, but these have been omitted for the sake of clarity.

Note that “signaling”, as used herein, may alternatively be called control signaling, control message, control information, or message for simplicity. Signaling between a BS (e.g., the network node 170) and a terminal or sensing device (e.g., ED 110), or signaling between different terminal or sensing device (e.g., between ED 110i and ED110j) may be carried in physical layer signaling (also called as dynamic signaling), which is transmitted in a physical layer control channel. For downlink the physical layer signaling may be known as downlink control information (DCI) which is transmitted in a physical downlink control channel (PDCCH). For uplink, the physical layer signaling may be known as uplink control information (UCI) which is transmitted in a physical uplink control channel (PUCCH). For sidelink, signaling between different terminal or sensing device (e.g., between ED 110i and ED110j) may be known as sidelink control information (SCI) which is transmitted in a physical sidelink control channel (PSCCH). Signaling may be carried in a higher-layer (e.g., higher than physical layer) signaling, which is transmitted in a physical layer data channel, e.g. in a physical downlink shared channel (PDSCH) for downlink signaling, in a physical uplink shared channel (PUSCH) for uplink signaling, and in a physical sidelink shared channel (PSSCH) for sidelink signaling. Higher-layer signaling may also called static signaling, or semi-static signaling. Higher-layer signaling may be radio resource control (RRC) protocol signaling or media access control – control element (MAC-CE) signaling. Signaling may be included in a combination of physical layer signaling and higher layer signaling.

It should be noted that in present disclosure, “information”, when different from “message”, may be carried in one single message, or be carried in more than one separate message.

One or more steps of the methods provided in this disclosure herein may be performed by corresponding units or modules, according to FIG. 4. FIG. 4 illustrates units or modules in a device or apparatus, such as in the ED 110, in the T-TRP 170, or in the NT-TRP 172. For example, a signal may be transmitted by a transmitting unit or by a transmitting module. A signal may be received by a receiving unit or by a receiving module. A signal may be processed by a processing unit or a processing module. Other steps may be performed by an artificial intelligence (AI) or machine learning (ML) module. The respective units or modules may be implemented using hardware, one or more components or devices that execute software, or a combination thereof. For instance, one or more of the units or modules may be a circuit such as an integrated circuit. Examples of an integrated circuit includes a programmed FPGA, a GPU, or an ASIC. For instance, one or more of the units or modules may be logical such as a logical function performed by a circuit, by a portion of an integrated circuit, or by software instructions executed by a processor. It will be appreciated that where the modules are implemented using software for execution by a processor for example, the modules may be retrieved by a processor, in whole or part as needed, individually or together for processing, in single or multiple instances, and that the modules themselves may include instructions for further deployment and instantiation. For other nodes/entities in this disclosure, similar units or modules applies.

Additional details regarding the EDs 110, the T-TRP 170, and the NT-TRP 172 are known to those of skill in the art. As such, these details are omitted here.

The proposed 6G system architecture is defined to support 6G XaaS services by using techniques such as network function virtualization and network slicing. The 6G system architecture utilizes service-based interactions between 6G services.

The 6G system leverages service-based architecture and XaaS concept. XaaS services in the 6G system are categorized into three layers. The 6G system conceptual structure is shown in FIG. 5.

Infrastructure layer includes infrastructures supporting 6G services. Among them are wireless networks (RAN, CN) infrastructures, cloud/data center infrastructures, satellite networks, storage/database infrastructures, and sensing networks, and etc. These infrastructures can be provided by a single provider or by multiple providers.

Each of the infrastructures could have its control and management functions, denoted as C/M functions, for infrastructure management. Each of these infrastructures is one type of Infrastructure as a Service.

Control and management (C/M) layer includes control and management services of the 6G System. They are developed and deployed by using slicing techniques and utilizing resource provided by infrastructure layer. 6G services in control and management (C/M) layer are:

Resource management (RM) as a Service provides a capability of life-cycle management of a variety of slices and over-the-air resource assignment to wireless devices.

A 6G mission is defined as a service provided to customers by the 6G System. A mission can be a type of services which is provided by a single 6G XaaS service or a type of services that needs contributions from multiple XaaS services.

Mission management (MM) as a service provides a capability to program provisioning of XaaS services at service layer to provide mission services.

Confederation network (CONET) as a Service provides a capability to enable multiple partners jointly provide 6G services. This capability is provided by confederation formation, mutual authentication, mutual authorization among partners and negotiation of agreement on recording and retracing of selected actions performed by partners, in order to assure a trustworthy environment of 6G System operations.

Service provisioning management (SPM) as a service provides a capability of control and management of 6G service access by customers and provisioning of requested services. The capability is provided by unified mutual authentication, authorization and policy, key management, QoS assurance and charging between any pair of XaaS service provider and customer. The customers include end-customers not only in physical world, but also digital representatives in digital world.

In some embodiments, QoS refer to quality of service.

Connectivity management (CM) as a Service leverages 5G connectivity management functions, but with extension to include digital world.

Protocol as a Service provides a capability to design service customized protocol stacks for identified interfaces.

The protocol stacks could be pre-defined for on-demand selection, or could be on-demand designed.

Network Security as a Service provides a capability for owners of infrastructures to detect potential security risks of their infrastructures.

XaaS services in C/M layer support control and management of the 6G system itself and also provide support to verticals if requested. One example is that RM service can serve RAN for over-the-air resource management and can also provide service to a vertical for the vertical’s over-the-air resource allocation to its end-customers. The XaaS in C/M layer can be deployed by using slicing technique.

Service Layer includes 6G services which provide services to customers. In the 6G System conceptual structure:

AI service is denoted as NET4AI as a Service. Artificial intelligence service provides AI capability to support a variety of AI applications.

Service of data collection, data sanitization, data analysis and data delivery are denoted as data analytics and management (DAM) as a Service, this service provides a capability of lifecycle management of statistic data, including acquisition, de-privatization, analysis and delivery of data which are information statistic data from any types of sensors, devices, network functions, and etc.

Service of storage and sharing of data is denoted as NET4Data as a Service, this service provides a capability to trustworthily storage and share data under the control of owners of data and following recognized authorities’ regulations on control of identified data.

Service to provide digital world is denoted as NET4DW as a service, digital world service provides a capability to construct, control and manage digital world. Digital world is defined as digital realization of physical world.

6G block chain service is denoted as NET4BC as a Service. 6G connectivity service is denoted as NET4Con as a service. This service provides a capability to support 6G block chain services.

Enhanced connectivity service, e.g., network for connectivity (NET4CON) as a service.

This service provides a capability to support exchange of messages and data among new 6G services.

All XaaS services at this layer are developed and deployed by using resource provided in infrastructure and utilizing network function virtualization and slicing techniques. The capability of each of 6G services is provided by its control and management functions and service specific data process functions.

In addition to support 6G XaaS services at service layer, 6G System leverages 5G System for provisioning of vertical services. The difference between 6G XaaS services and other verticals are that a vertical is a pure customer which needs other XaaS services to enable its operation, while each of XaaS services provide their capabilities to 6G customers.

Any pair of XaaS services of the 6G System could also be mutual customer and provider of each other. Some of example are that an infrastructure owner provides its resource to XaaS services in service layer and C/M Layer; RM services may need the capabilities provided by NET4AI, DAM and NET4DW for its resource management for vertical slicing; CONET service and NET4Data service may need the capability provided by NET4BC for their operation.

The key concepts of 6G system includes:

Define basic XaaS services by decoupling comprehensive types of services into basic XaaS services. A basic XaaS service provides unique capability to enable a specific type of service, such as NET4AI service, NET4DW service, DAM service, NET4Data service, Block chain service, mission management service, etc.

Allow joint operation of the 6G system by multiple partners.

Define data plane of the 6G system which includes processing functions of data plane of XaaS services. Programing the interconnection of these functions, by mission management service, enables to support a variety of customized customer services.

Simplify 6G System architecture by categorizing basic control services and management services and combining them as basic XaaS services in control and management (C/M) Layer.

Define C/M plane of the 6G system which includes C/M functions in XaaS services and may include 5G control plane (CP) (e.g., AMF) depending on implementation options.

Define basic architecture structure (BAS) which is a unified basic structure with minimized number of interfaces and is independent of types of infrastructures.

Simplify standardization, development and deployment of the 6G System using the BAS concept, while supporting a variety of infrastructure deployment scenarios.

Adapt to a variety of deployment scenarios by applying the BAS or a subset of it to infrastructures based on capability, capacity and requirement of the infrastructure networks.

Leverage simplify service based interface (SBI) interface concept and apply SBI interaction in both 6G C/M plane and 6G data plane.

Simplify service based Interface (SBI) interfaces by introducing trustworthy GWs in Data Plane and C/M Plane of the 6G System.

Improve trustworthiness from perspectives of operation of the 6G system by introducing CONET capability, NET4BC capability and anonymous service provisioning provided by the trustworthy GWs in the C/M plane and data plane of the 6G System.

Improve trustworthiness from perspective of end customer privacy protection by unified mutual authentication, identifier management (IDM), data sanitization and etc. provided by SPM service, DAM service and 6G Block Chain service.

Simplify roaming management of wireless devices, in physical world and digital world, by unified authentication including all participated partners and customers.

Support multiple development paths from 5G System to 6G System by defining multiple architecture options without incurring much efforts due to the introduction of the BAS concept.

Support backward compatibility by utilizing benefits of SBA and its add-on feature. 5G users can use the 6G system to access 5G services.

Support future extension by adding new XaaS services with minimized impact on standardization and deployment, due to the introduced anonymous service provisioning concept implemented in trustworthy GWs in 6G C/M plane and in 6G data plane.

The architecture of the 6G system shown in FIG. 5 is just an example. In other embodiments, the 6G system may include more or fewer layers, and different layers may also be merged or split, which is not limited herein.

In some embodiments, the service layer may comprise more or fewer services, and some services may also be merged or split, which is not limited herein.

The system performs ME management and data processing function re-location provided in this disclosure using an architecture illustrated in FIG. 6. The architecture includes a number of network functions: mission customer, MM, TCF, and PSF. In some embodiments, the apparatus, units and modules shown in FIGS. 3 and 4 may also applied for Device/DN, MM, TCF, and PSF.

Mission customer (MC): An authorized network entity, e.g. an application function (AF), a device, or a network function, can send a request to the MM to request a ME. The authorized network entity is referred to as mission customer (MC).

Mission management (MM): The MM includes control/management plane (CP) functions to manage/coordinate one or multiple ME(s). The MM controls and coordinates an ME over an instance of the mission, including starting, pausing, resuming, stopping, terminating the ME. The MM starts, pauses, resumes, stops or terminates the ME according to a request (e.g. from a MC) or upon certain event (e.g. a time event). The MM is responsible for establishing data plane paths among computing block (CB) instance(s) (CBI)within the mission instance and between mission participants (e.g. UEs) and the CB instance(s) for the mission execution. When coordinating the mission execution, the MM triggers execution(s) of the CB(s) of the mission at right time and coordinates access of mission participants, e.g. devices, to the mission execution. The MM may control the mission execution with respect to relevant MM polices, which can be pre-configured at the MM or obtained by the MM from another control plane entity. Mission context related to the ME is maintained in the CP and in the DP before the ME is terminated.

Task control function (TCF): The TCF controls and coordinates a TE, including starting, stopping, and terminating the TE. The TCF starts, stops or terminates the TE as part of a ME according to request(s) from the MM. The TCF is informed by the MM that a network entity, e.g. a device, is accessing/participating the TE. The TCF can accordingly invite the network entity at right time, e.g. when task resources are ready, to access/participate the TE, wherein the network entity may provide data to support the task execution or receives data related to the TE. Task context related to the TE is maintained in the CP of the service module and in the DP of the service module before the task execution is terminated.

Processing service function (PSF): The PSF receives and processes DP traffic. The PSF may generate data plane traffic. The PSF may transmit its received data plane traffic (possibly after processing) or generated data plane traffic to other PSFs or the DN or the UE via one or multiple data plane gateways, a.k.a. data gateways (data GWs), which are similar to UPFs (user plane functions) in the 5G system.

In some embodiments, a mission may include at least one task. Each task can be executed by a PSF managed by TCF. The specific content of a mission is determined by the corresponding XaaS service or MC, such as missions for AI infer (such as model training, model inferring), data processing missions (such as image processing, audio processing), and data collection missions (such as collecting images, videos, signals, audio, etc.),etc.

In some embodiments, PSFs managed by a TCF may execute multiple tasks (of one or more missions), which is not limited herein.

For the convenience of description, in the following description, the content of a certain task executed by a PSF refers to sub-task, and a task may include one or more sub-tasks. In some embodiments a sub-task refers to a TE.

In some embodiments, PSF, TCF, MM or other function modules may be deployed in one or more network entities. And the network entity may be physical (such as apparatus comprising one or more processors), or it can be logical (such as a virtual machine, a thread or process, etc.).

In some embodiments, one or more PSFs may be deployed in a network entity deploying one or more TCF(s) and/or MM(s).

For illustrative purposes, specific example embodiments will now be explained in greater detail in conjunction with the figures and above mentioned system, ED, TRP and network nodes.

The embodiments set forth herein represent information sufficient to practice the claimed subject matter and illustrate ways of practicing such subject matter. Upon reading the following description in light of the accompanying figures, those of skill in the art will understand the concepts of the claimed subject matter and will recognize applications of these concepts not particularly addressed herein. It should be understood that these concepts and applications fall within the scope of the disclosure and the accompanying claims.

A mission is to achieve a designated goal, known as mission goal, which includes 1) providing PDU connectivity and optionally 2) providing data processing. When the mission goal includes providing data processing, the mission goal is associated with specific computational problem(s), and providing data processing refers to solving the specific computational problem(s). In this case, the mission includes one or multiple computing blocks (CBs) and is associated with a networking procedure among the CBs for solving the specific computational problem(s). A CB within the mission corresponds to a defined computational step toward the mission goal (i.e. solving the specific computational problem(s)) and may be supported by a service (in the form of a task), a data network (DN), or another mission; accordingly, the CB is referred to as a task CB, an external CB or a sub-mission CB. Mission management includes programming a mission, instantiating a mission and achieving a mission goal.

A mission slice is a logical network that provides specific capabilities and characteristics in networking and computing (including storage) for a mission. A CB within the mission corresponds to a subnet, referred to as CB subnet, of the mission slice. The CB subnet provides computing functionalities of achieving the corresponding computational step toward the mission goal. A mission slice instance incudes a set of network function instances and the required resources (e.g. computing, storage, and networking resources) and computing logic (e.g. in terms of parameter configuration) which form a deployed mission slice. A mission service is a service that provides achievement of a mission goal, a.k.a. executing of a mission, between a network entity (NE), e.g. a UE or an AS, and a DN. A mission session refers to an association between an NE and a DN, providing a mission service with support from a mission slice instance.

Without ambiguity, mission and mission slice are used interchangeably for ease of presentation unless clarified; likewise, CB and CB subnet are used interchangeably. When a mission is instantiated, a mission slice instance is created for the mission. The mission slice instance is thus considered an instance of the mission. For each CB within the mission, the mission instance includes an instance of the CB. If the CB is a task CB, the CB instance is located in a XaaS service module (or, a service module for simplicity) supporting the task CB; if the CB is an external CB, the CB instance is located in the respective DN; if the CB is a sub-mission CB, the CB instance is an instance of a mission corresponding to the CB. The mission can have multiple instances. A CB instance may be shared by multiple mission instances when the CB instance is stateless. Likewise, a mission instance may be shared by (i.e. support) multiple applications when the mission instance is stateless. A mission instance is stateless if and only if the mission instance does not include stateful CB instances.

An application located in a DN can be a customer of a mission and provide an application service to its users by making use of an execution of the mission. The mission can support more than one application. A mission supports an application through a mission instance. A mission can act as an application and natively provides an application service to the application users; in this case, the application is considered to be located in the mission. An authorized NE uses a mission session to access the application, the mission session targeting a DN where the application is located and being supported by an instance of the mission. When the application is located in the mission, the DN is an abstract DN and corresponds to the mission. The mission instance can be used to support more than one application. Different applications may be supported by different instances of a mission.

To support an application through a mission instance as described above, a mission session may be established over the mission instance. During the establishment of the mission session, both the data plane (e.g. data plane path(s) across CB instance(s)) and the control plane (e.g. MCF(s) and TCF(s)) are configured for the mission session.

After the mission session establishment, data traffic related to the application can flow through the mission instance and be processed under the coordination of the MM framework, according to a networking logic (if any) associated to the mission. The process of coordinating the data flow and processing are referred to as mission execution (ME) process (or ME in short). A ME comprises one or multiple task execution(s) (TEs) according to the networking logic (if any) associated to the mission. A TE is referred to as the execution of a CB comprising one or multiple execution(s) of data plane (DP) computing/processing function(s) according to pre-defined execution dependency and/or logic (if any) associated to the CB. The ME management service is responsible for initiating, coordinating and terminating a ME process.

In some embodiments, if a certain sub-task is fixed to a PSF for execution, it may lead to low execution efficiency of the sub-task or low efficiency of the communication system.

For example, if the computing resources or communication resources available in the network entity where the PSF is deployed are insufficient to complete the execution of the sub-task, the PSF will wait until the computing resources and communication resources of the network entity are sufficient before continuing to execute the sub-task, resulting in a delay in execution of the sub-task.

For another example, if there are multiple network entities with similar or identical functions in the communication system, running more PSF on one network entity and running less PSF or no PSF on another network entity will cause the problem that : some network entities may run with long-term high load while other network entities may run with long-term low load. In this way, some network entities will suffer performance degradation or even damaged due to long-term high load operation.

In view of the above description, the embodiment of the present disclosure provides a communication method. When the re-location condition is met, the sub-task executed on one PSF can be re-located to another PSF for execution (for the convenience of description, the process of re-locating a sub-task executing on a PSF to another PSF for execution is called data processing function re-location or PSF re-location procedure or PSF re-location). Therefore, the sub-task can be executed effectively or the resources in the communication system can be balanced.

For example, in some embodiments, the reasons for ME to perform data processing function re-location (that is, meet the re-location condition) may include one or more of the following conditions: scarcity of computing/communication resources on the network entity where the PSF is deployed, communication system (such as MM, TCF or other network elements)) determines to perform load balancing on a PSF or a network entity deploying one or more PSFs, or available resources of a PSF is not sufficient for the execution of the corresponding sub-task.

For example, MM or TCF or XaaS may monitor available computing resources (such as processor resources, memory resources, etc.) and/or communication resources (such as channel bandwidth, quality of service (QoS) of PSFs. If available computing resources and/or communication resources of a certain PSF is insufficient for executing the corresponding sub-task, the data processing function re-location of the PSF can be triggered to re-locate the sub-task to another PSF with sufficient computing resources and communication resources for execution. In this way, it is avoided that the sub-task cannot be executed in a timely and effective manner due to insufficient computing resources and/or communication resources on the PSF, which is beneficial to improving the efficiency of sub-task execution.

For another example, if the MM or TCF monitors that there are too many sub-tasks running on a certain network entity and that there are fewer sub-tasks running on another network entity with the same or similar functions, the MM or TCF can trigger load balancing. In this way, at least part of the sub-tasks running on the certain network entity can be re-located to the another network entity, so that the load on each network entity in the communication system is balanced.

It should be understood that in the embodiments of this disclosure, trigger PSF re-location with MM or TCF or XaaS is just an example. In other embodiments, PSF re-location can also be triggered by other network elements or network entities or functional modules. It is not limited herein.

It should be understood that in the various embodiments of the present disclosure, the re-location condition introduced in terms of insufficient computing resources/communication resources of the network entity deploying the PSF and load balancing performed by the communication system are just examples. In other embodiments, the re-location condition may also include more or less conditions, which is not limited herein. For example, in the communication system, when the network entity where one or more PSFs are deployed is unreachable (such as network failure, equipment failure, etc.), re-location of the PSF deployed on the network entity can be triggered.

PSF re-location procedure: the PSF re-location procedure is a procedure to change a PSF of an on-going TE to a new PSF which may have different location as the previous PSF. A PSF re-location procedure can be enabled by either the MM or the XaaS service (e.g., the TCF) during a ME process. In a PSF re-location procedure, the o-PSF is referred to as the old PSF which will be discarded after the PSF re-location completed; the n-PSF is referred to as the new PSF which will replace the o-PSF.

In some embodiments, for the convenience of description, the sub-task running on the o-PSF is called the target sub-task, and the PSF(s) executing sub-task corresponding to target sub-task is called related PSF(r-PSF), the TCF managing r-PSF(s) is called related TCF (r-TCF).

In some embodiments, when the target sub-task running on o-PSF is re-located to n-PSF, the execution data of the o-PSF execution target sub-task (for example, the intermediate data obtained by executing the target sub-task, the execution progress of the target sub-task, the PSF identification of r-PSF (if it exists), etc.) are synchronized to n-PSF. In this way, after receiving the execution data, n-PSF can continue to execute the target sub-task based on the execution progress and intermediate data of the target sub-task in the execution data without re-executing the target sub-task, which is beneficial to improving the execution efficiency of the target sub-task.

In some embodiments, the r-PSF may be PSF that provides information for the execution of the target sub-task (e.g., data required to execute the target sub-task, control signaling, etc.), or PSF that obtains information from the target sub-task (e.g., obtains the execution results and/or execution progress of the target sub-task.

In some embodiments, before synchronizing the execution data of the target sub-task to n-PSF, the execution of the r-PSF can also be suspended, and the data forwarding relationship between r-PSF and o-PSF can be adjusted to the data forwarding relationship between the r-PSF and n-PSF. For example, if the r-PSF is PSF that provides information for the execution of the target sub-task, the destination address of the data sent by the r-PSF (that is, the network address of the o-PSF) can be adjusted to the network address of the n-PSF. For another example, if the r-PSF is PSF that obtains information from the target sub-task, the source address of the r-PSF obtaining information (that is, the network address of the o-PSF) can be adjusted to the network address of the n-PSF.

In some embodiments, after synchronizing the execution data of the target sub-task to the n-PSF, the execution of the associated r-PSF can be resumed.

In some embodiments, the MM can monitor the operation status of the network entities where each PSF corresponding to an MC is located (such as the computing resources and communication resources available to each network entity or each PSF, the load status of each network entity, etc.). If the MM monitors the computing resources/communication resources in the network entity where a certain PSF is located are insufficient to run the PSF, the MM can trigger PSF re-location of the PSF. If the MM monitors that the load of a certain network entity is high, and the load of other network entities with the same or similar functions is low, MM can trigger the PSF re-location of PSF(s) in network entities with higher load.

In some embodiments, TCF can also monitor the operation status of multiple PSFs it manages (such as computing resources and communication resources available to the network entity where the PSF is located, the load status of each network entity, etc.). If TCF monitors that the computing resources/communication resources in the network entity where a certain PSF is located are insufficient to run the PSF, TCF can trigger PSF re-location of the PSF. If TCF monitors that the load of a certain network entity is high, and another If the load of a network entity with the same or similar functions is low, MM can trigger the re-location of data processing functions to the PSF deployed in the network entity with higher load.

In some embodiments, the reasons of data processing function re-location during the ME process are: computing/communication resource scarcity on network entities embedding the data processing function; and/or the load balancing decision made by the network or ME controller requires the re-location of a data processing function.

The AF triggered DP routing/PDU session modification methods cannot be triggered by network, and the modification targets are only the location of the data plane (DP) function and the PDU sessions involving the DP function, which do not include the processed/computed data on the DP function dynamically re-locate/modify the PSF during a ME process is not disclosed, and method for customizing the TE behavior(s) during a ME process (which can be a sub-procedure involved in the method to re-locate the PSF during a ME process) is not disclosed.

Accordingly, a method for a data processing function re-location is provided in the disclosure. The data processing function re-location is referred to as changing the data processing function involved in a TE of the ME from an old data processing function to a new data processing function during the ME process. The old data processing function and the new data processing function may have different locations (i.e., network addresses).

Next, combined with the architecture shown in FIG. 6, the technical solution of this disclosure is introduced.

FIG. 7A shows a diagram of mission M1 according to some embodiments of the present disclosure. FIG. 7B shows an execution diagram of mission M1 by the structure of FIG. 6 according to some embodiments of the present disclosure. FIG. 7C shows an execution diagram of mission M1 by the structure of FIG. 6 after re-location of PSF 023 according to some embodiments of the present disclosure.

As shown in FIG. 7A, mission M1 includes task TA1, task TA2, task TA3, and task TA 4. Task TA1 includes sub-task TA1.1, sub-task TA1.2 and sub-task TA1.3. Task TA2 includes sub-task TA2.1 and sub-task TA2.2. Task TA3 includes sub-task TA3. task TA4 includes sub-task TA4.1, sub-task TA4.2 and sub-task TA4.3.

In some embodiments, the input data of sub-task TA1.1 is the input of mission M1. The output data of sub-task TA1.1 is the input data of sub-task TA1.2. The output data of sub-task TA1.2 is the input data of sub-task TA1.3. The output data of sub-task TA1.3 is the input data of sub-task TA2.1 and sub-task TA4.2. The output data of sub-task TA2.1 is the input data of sub-task TA2.2. The output data of sub-task TA2.2 is the input data of sub-task TA3.1. The output data of sub-task TA3.1 is the input data of sub-task TA4.1. The output data of sub-task TA4.1 and the input data of sub-task TA4.2 are the input data of sub-task TA4.3. The output data of sub-task TA4.3 is the output of mission M1.

Referring to FIG. 7B, in some embodiments, MM 01 may be used to manage the execution of mission M1. For example, MM 01 can assign task TA1 to TCF 02 for processing, assign task TA2 and task TA3 to TCF 03 for processing, and assign task TA4 to TCF 03 for processing.

In some embodiments, TCF 02 may execute sub-task TA1.1, sub-task TA1.2, and sub-task TA1.3 through PSF 021, PSF 022, and PSF 023, respectively.

In some embodiments, TCF 03 may execute sub-task TA2.1, sub-task TA2.2 and sub-task TA3.1 through PSF 031, PSF 032 and PSF 033 respectively.

In some embodiments, TCF 04 may execute sub-task TA4.1, sub-task TA4.2, and sub-task TA4.3 through PSF 041, PSF 042, and PSF 043, respectively.

Assume that the PSF to be re-located is PSF 023 (as o-PSF) (correspondingly, sub-task TA1.3 can be adopted as the target sub-task), then the corresponding r-PSF of PSF 03 includes PSF 022, PSF 031 and PSF 042, the r-TCF corresponding to PSF 023 may include TCF 03 and TCF 04. MM 01 or TCF 02 can determine a PSF as an n-PSF (for example, PSF 024) from the PSF(s) managed by TCF 02.

Referring to FIG. 7C, TCF 02 can control PSF 022 to suspend the execution of sub-task TA1.2, and adjust destination address for outputting results of sub-task TA1.2 from the network address of PSF 023 to the network address of PSF 024. Correspondingly, MM 01 can control PSF 031 through TCF 03 to suspend the execution of sub-task TA 2.1 and change the source address of receiving input data of sub-task TA 2.1 from the network address of PSF 023 to the network address of PSF 024. MM 01 can also control PSF 042 through TCF 04 to suspend the executing sub-task TA 4.2 and change the source address of receiving input data of sub-task TA 4.2 from the network address of PSF 023 to the network address of PSF 024.

Then, TCF 02 can control PSF 023 to synchronize the execution data corresponding to sub-task TA 1.3 to PSF 024. In some embodiments, the execution data may include at least one of the following data: PSF identification of r-PSF, execution progress of sub-task TA 1.3 or intermediate data obtained by executing the sub-task TA 1.3.

Again, after PSF 023 synchronizes the execution data corresponding to sub-task TA 1.3 to PSF 024, TCF 02 can control PSF 022 to resume execution of sub-task TA1.2. Correspondingly, MM 01 can control PSF 031 through TCF 03 to resume execution of sub-task TA 2.1, and control PSF 042 through TCF 04 to resume execution of sub-task TA 4.2.

Based on the above process, switching from PSF 023 to PSF 024 can be achieved.

Next, with reference to FIGS. 6 and 7, a communication method that PSF re-location is triggered by MM will be introduced.

As shown in FIG. 8, a method for MM enabled PSF re-location is provided in this disclosure.

The PSF re-location procedure can be enabled by the MM during a ME process. To executing a MM enabled PSF re-location procedure, the MM may have information of all available PSF(s) (e.g., defined in the mission template, or subscribed from the network repository function (NRF)). FIG. 8 shows the MM enabled PSF re-location procedure:

S8.1, MM performs PSF load/traffic monitoring.

In details, MM keeps monitoring the computing and traffic loads info on available PSF(s) which may include at least one of o-PSF and n-PSF.

In some embodiments, the MM can monitor the operation status of the PSFs it manages or can connect to.

In some embodiments, operation status may comprise at least one of the following information: available computing resources of PSF or network entity deploying PSF, available and communication resources of PSF or network entity deploying PSF, or the load status of network entities deploying PSF(s).

For example, in some embodiments, the MM can obtain the operation status of the PSF managed from each TCF or the network entity deploying the PSF by sending an operation status request to the managed or connectable TCF.

For another example, in some embodiments, each TCF or PSF may actively send its respective operation status to the corresponding MM.

It should be understood that in other embodiments, the operation status of each PSF may also include more or less information, which is not limited herein.

For example, corresponding to the situations shown in FIGS. 7A to 7C, MM 01 can monitor the operation status of the PSFs managed by TCF 02, TCF 03 and TCF 04.

S8.2, MM performs PSF re-location determination.

In details, MM determines to re-locate an old PSF (o-PSF) according to the monitored info due to resource scarcity on o-PSF or load balancing decisions.

For example, if the MM monitors that the computing resources/communication resources in the network entity where a certain PSF is located are insufficient to run the sub-task performed by the PSF, the MM can determine the PSF as an o-PSF and trigger PSF re-location to the o-PSF.

For another example, if the MM monitors that the load of a certain network entity is high and the load of another network entity with the same or similar functions is low, the MM can determine the PSF running in the network entity with the higher load as o-PSF. And the MM may perform PSF re-location determination to trigger PSFre-location for o-PSF to balance the load of the one network entity and the other network entity.

For another example, if the MM receives a PSF re-location instruction for a certain PSF sent by the MC (or other functional module/network entity) corresponding to the PSF, the MM can determine the PSF as o-PSF and trigger PSF re-location for the PSF.

It should be understood that in other embodiments, the MM may also determine one or more PSFs as o-PSFs and trigger PSF re-location for o-PSFs under other circumstances, which is not limited here.

For example, corresponding to the situations shown in FIGS. 7A to 7C, MM 01 can determine PSF 023 as o-PSF when the communication resources or computing resources available to PSF 023 are insufficient to complete the execution of sub-task TA 1.3 or load balancing on the network entity where PSF 023 is located is required.

In some embodiments, re-location determination may be made after monitoring that a certain PSF meets the re-location condition. For example, re-location condition may include at least one of the following conditions:

available communication resources and/or computing resources of the PSF cannot satisfy the execution of the target sub-task (e.g. available communication resources is less than a first threshold, and/or available computing resources is less than a second threshold), or determine to execute a load balancing policy on a network entity corresponding to a PSF.

S8.3, MM selects a new PSF (n-PSF) to replace the o-PSF.

In some embodiments, the MM may select one of the PSFs managed by the TCF that manages the o-PSF as an n-PSF after there-location determination is made.

In some embodiments, the MM may select n-PSFs based on selection criteria. The selection criteria may include:

The n-PSF must be within the same CBI as the o-PSF (ensure the n-PSF be managed by the same TCF).

Location of the n-PSF, e.g., close to all connected PSF(s) of the o-PSF; close to the TCF.

Available resources on the n-PSF, e.g., whether the n-PSF has sufficient computing/communication resources.

That is, in some embodiments, the MM can determine n-PSF based on one or more of the above selection criteria.

For example, the MM can obtain the operation status of the PSF managed by the TCF that manages the o-PSF, and select a PSF whose available resources satisfy the operation of the target sub-task from the PSFs managed by the TCF as the n-PSF.

It should be understood that in other embodiments, the selection criteria may include more or less selection criteria, which is not limited herein.

It should be understood that in other embodiments, if the TCF that manages the o-PSF does not have a PSF that meets the above selection criteria, the MM can also select one from the PSFs managed by other TCFs as the n-PSF.

For example, corresponding to the situations shown in FIGS. 7A to 7C, MM 01 can select a PSF from the PSF managed by TCF 022 whose available communication resources and computing resources can satisfy the operation of sub-task TA 1.3 (e.g. PSF 024) as n-PSF.

S8.4, The MM may trigger TE customization procedure(s) to related on-going TE(s) (i.e., related TE(s)) which can be influenced by the PSF re-location. The PSF(s) in a related TE are referred to as r-PSF, and the TCF of a related TE is referred to as r-TCF. The customization content defined in the TE customization procedure(s) can be: Pause the TE; Revise the DP forwarding destination to the address of the n-PSF at a scheduled future time, which can avoid TE pause.

In some embodiments, pausing the TE refers to suspend execution of sub-task executing on the r-PSF.

TE customization procedure will be described later. This step is optional.

In some embodiments, if there is a r-PSF associated with an o-PSF, the MM can trigger the r-TCF corresponding to the r-PSF to suspend the operation of the r-PSF, and adjust the data forwarding relationship between the r-PSF and the o-PSF to the data forwarding relationship between the r-PSF and the o-PSF.

For example, for the r-PSF providing information for the execution of o-PSF, the destination address for sending information (that is, the network address of the o-PSF) can be adjusted to the network address of the n-PSF. For r-PSF obtaining information from the o-PSF, the source address for receiving information (that is, the network address of the o-PSF) can be adjust to the network address of the n-PSF.

For example, corresponding to the situations shown in FIGS. 7A to 7C, MM 01 can control PSF 031 through TCF 03 to suspend the execution of sub-task TA 2.1 and adjust source address for receiving the input data corresponding to sub-task TA 2.1 from the network address of PSF 023 to the network address of PSF 024. MM 01 also can control PSF 042 through TCF 04 to suspend the execution of sub-task TA 4.2 and adjust source address for receiving the input data corresponding to sub-task TA 4.2 from the network address of PSF 023 to the network address of PSF 024.

Due to step S8.4, the execution of r-PSF(s) may be suspended before the PSF re-location, which may avoid the PSF re-location procedure affecting the operation of r-PSF(s).

S8.5, PSF re-location request from MM to TCF (of the o-PSF and the n-PSF): request the TCF to replace the o-PSF by the n-PSF. The ID/name and location of the n-PSF are included in the PSF re-location request.

In some embodiments, the re-location request may include PSF identifiers of o-PSF and n-PSF, such as ID, name, and network location.

In some embodiments, the PSF identifier may be any identifier capable of distinguishing different PSFs, including but not limited to the name, ID, etc.

For example, corresponding to the situations shown in FIGS. 7A to 7C, MM 01 may send a re-location request to TCF 02to instruct TCF 02 to perform PSF re-location on PSF 023 (switch the sub-task TA1.3 from PSF 023 to PSF 024 for execution). In some embodiments, the re-location request may include the PSF identifiers of o-PSF (PSF 023) and n-PSF (PSF 024).

It should be understood that in other embodiments, the re-location request may also include other information, which is not limited here.

S8.6, after receiving the PSF re-location request in step S8.5, the TCF may trigger TE customization procedure(s) for all on-going TE(s) managed by it which may be impacted by the PSF re-location. This step is optional.

In some embodiments, the TCF may send a PSF execution customize request to the r-PSF(s) managed by the TCF. Wherein the PSF execution customize request instructs the r-PSF to suspend the PSF execution (suspend execution of the sub-task executing on the r-PSF), and/or adjust data forwarding relationship.

In some embodiments, if r-PSF(s) associated with the o-PSF exists in the PSFs managed by the TCF managing the o-PSF, the TCF can suspend the r-PSF, and adjust the data forwarding relationship between r-PFS and o-PSF to the data forwarding relationship between r-PSF and n-PSF.

For example, for the r-PSF providing information for the execution of the target sub-task, the destination address for sending information (that is, the network address of the o-PSF) can be adjusted to the network address of the n-PSF. For r-PSF obtaining information from the o-PSF, the source address for receiving information (that is, the network address of the o-PSF) can be adjust to the network address of the n-PSF.

For example, corresponding to the situations shown in FIGS. 7A to 7C, TCF 02 can control PSF 022 to suspend the execution of sub-task TA1.2 and adjust the destination address for outputting data corresponding to sub-task TA1.2 from the network address of PSF 023 to the network address of PSF 024.

In some embodiments, the PSF execution customize request further instructs the r-PSF to resume execution of the suspended sub-task after suspended for a certain duration.

Due to step S8.6, the execution of r-PSF(s) managed by the TCF managing the o-PSF may be suspended before the PSF re-location, which may avoid the PSFre-location procedure affecting the operation of r-PSF(s).

S8.7, TCF triggers the n-PSF configuration procedure to configure the n-PSF with PSF execution parameters, which may include at least one of: connected data session ID(s), data forwarding rules.

PSF data synchronization rule (e.g., location of the o-PSF, interface and QoS for receiving the data from o-PSF) for synchronizing data with o-PSF, which will be used in step S8.8.2.

In some embodiments, the connected data session ID may include the session ID of sessions that the o-PSF communication with other devices or entities or modules. For example, the connected data session ID can include the session ID of the session(s) used by o-PSF to perform target sub-tasks.

In some embodiments, data forwarding rules may include the source address of obtaining data and/or destination address of output data when n-PSF executes a task.

In other embodiments, PSF execution parameters may also include more or less parameters, which are not limited here.

In some embodiments, the connected data session ID(s) may indicate the data session(s) between o-PSF and r-PSF(s), hence the n-PSF may construct/reconstruct/connect to those data session(s) based on the connected data session ID(s) to replace the function of o-PSF for sending/receiving data from r-PSF(s).

The n-PSF configuration includes following sub-steps:

S8.7.1, n-PSF configuration request from TCF to n-PSF: request configuring the n-PSF according to the PSF execution parameters which are included in the request.

For example, corresponding to the situations shown in FIGS. 7A to 7C, TCF 02 may send a configuration request to PSF 024. The configuration request may comprise: the session ID of the session used by PSF 023 in executing sub-task TA1.3, the source address for obtaining data (such as the network address of PSF 022), the destination address for outputting data (such as the network addresses of PSF 031 and PSF 042), PSF data synchronization rule, etc.

S8.7.2, n-PSF configuration request response from n-PSF to TCF: the n-PSF configures/modifies its local setting according to the received PSF execution parameters in step S8.7.1. Then, the n-PSF sends this response to the TCF to indicate the completion of the n-PSF configuration.

For example, corresponding to the situations shown in FIGS. 7A to 7C, PSF 024 may configure based on the configuration request sent by TCF 02 and send a configuration request response to TCF 02 to indicate that n-PSF has been configured after the configuration is completed.

S8.8, TCF performs PSF synchronization.

In details, TCF establishes a temporary data session between the o-PSF and n-PSF, and triggers a PSF synchronization procedure to synchronize the o-PSF execution data to the n-PSF. The o-PSF execution data include: 1) info of dependent PSF(s) (e.g., PSF ID(s)); info of on-going PSF execution (e.g., percent of completion); cached intermediate data generated by the on-going PSF execution; etc. The PSF synchronization procedure includes:

S8.8.1, PSF sync request from TCF to o-PSF: request the o-PSF to synchronize its o-PSF execution data to the n-PSF. The PSF sync request include: 1) ID/name and location of the n-PSF; 2) PSF data synchronization rule (e.g., interface and QoS for sending the o-PSF execution data to the n-PSF) for synchronizing data with n-PSF.

For example, corresponding to the situations shown in FIGS. 7A to 7C, TCF 02 can send a synchronization request to PSF 023. The synchronization request can comprise the PSF identity and/or network location of PSF 024, and/or PSF data synchronization rule (e.g., interface and QoS for sending the execution data in PSF 023 to PSF 024).

In some embodiments, TCF 02 may also first establish a temporary session between PSF 02 and PSF 024, and send the session ID of the temporary session to PSF 023 along with the synchronization request. For example, TCF can embed the session ID of the temporary session into the synchronization request and send it to PSF 024.

S8.8.2, The o-PSF synchronizes o-PSF execution data to the n-PSF according to the TCF data synchronization rule received in step S8.8.1.

For example, corresponding to the situations of FIGS. 7A to 7C, after receiving the synchronization request, PSF 023 can send execution data corresponding to sub-task TA1.3 to PSF 024 based on the temporary session between PSF 023 and PSF 024.

S8.8.3, PSF sync request response from o-PSF to TCF: inform the TCF about the completion of synchronizing the o-PSF execution data to the n-PSF.

For example, corresponding to the situations of FIGS. 7A to 7C, after sending the execution data corresponding to sub-task TA1.3 to PSF 024, PSF 023 can send a synchronization request response to TCF 02 to indicate that PSF 023 has sent the execution data of sub-task TA1.3 to PSF 024.

S8.8.4, n-PSF sync complete message from n-PSF to TCF: inform the TCF that the n-PSF has successfully received all o-PSF execution data. The PSF synchronization procedure is completed after the TCF received both S8.8.3 and S8.8.4 messages.

For example, corresponding to the situations of FIGS. 7A to 7C, after receiving all execution data corresponding to sub-task TA1.3, PSF 024 can send a synchronization complete message to TCF 02 to indicate execution data of sub-task TA1.3 in PSF 023 has all been synchronized to PSF 024.

In some embodiments, after receiving the n-PSF synchronization complete message, the TCF can also send a resume execution request to the r-PSF managed by the TCF, so that the r-PSF can resume the suspended execution of the sub-task associated with the target sub-task. For example, corresponding to the situations in FIGS. 7A to 7C, after receiving the synchronization complete message sent by PSF 024, TCF 02 can send a resume execution request to PSF 022 to instruct PSF 022 to resume execution of sub-task TA1.2.

In some embodiments, TCF can also send a synchronization request to n-PSF, and n-PSF triggers o-PSF to synchronize the execution data corresponding to the target sub-task to n-PSF. For example, for the aforementioned situation shown in FIGS. 7A to 7C, TCF 02 may send a synchronization request to PSF 024. After receiving the synchronization request, PSF 024 can obtain the execution data corresponding to sub-task TA1.3 from PSF 023. Moreover, after PSF 024 obtains the execution data corresponding to sub-task TA1.3, PSF 024 may also send a synchronization complete message to TCF 02.

S8.9 PSF re-location request response from TCF to MM: TCF notify the MM about the PSF re-location procedure complete.

In some embodiments, after receiving the re-location response, the MM may send a resume execution request to r-TCF to instruct r-TCF to resume execution of the managed r-PSF. For example, for the aforementioned situations shown in FIGS. 7A to 7C, TCF 02 may send a re-location response to MM 01 after receiving the synchronization complete message sent by PSF 024. After receiving the re-location response, MM 01 may send resume execution requests to TCF 031 and TCF 024 respectively to request TCF 03 to control PSF 031 to resume execution of sub-task TA2.1, and to request TCF 04 to control PSF 042 to resume execution of sub-task TA4.2.

Based on the above method, MM can perform re-location of a certain PSF when it satisfies the re-location condition. In this way, the load of each PSF or network entity in the communication system can be balanced, and/or the target sub-task execution failure due to insufficient resources can be avoided.

The MM enabled PSF re-location procedure enables the dynamic PSF(s) re-location during a ME process, which can solve the PSF resource scarcity and load balancing problems during the ME process.

In some embodiments, n-PSF can also be selected by the TCF managing the o-PSF. As shown in FIG. 9, a method for XaaS enabled PSF re-location is provided in this disclosure.

In some implementations, the MM may not have all available PSF information. As an alternative method, the PSF re-location procedure can be enabled by the controller(s) of the o-PSF and n-PSF in XaaS service (e.g., the TCF) during a ME process. FIG. 9 shows the XaaS enabled PSF re-location procedure:

S9.1, as same as S8.1 in MM enabled PSF re-location procedure.

MM may perform PSF load/traffic monitoring. In some embodiments, MM keeps monitoring the computing and traffic loads info on available PSF(s) which may include at least one of o-PSF and n-PSF. For example, the MM may monitor the operation status of those PSF(s) which executing subtask(s) associated with to the mission the MM managed.

S9.2, as same as S8.2 in MM enabled PSF re-location procedure.

MM may perform PSF re-location determination.

In some embodiments, MM determines to re-locate an old PSF (o-PSF) according to the monitored info due to resource scarcity on o-PSF or load balancing decisions, in which the details refer to aforementioned step S8.2.

S9.3, PSF re-location request from MM to TCF (which manages the o-PSF and to select the n-PSF): request the TCF to select an n-PSF for re-location. The request may include the PSF selection requirements, e.g. minimal available resources on the n-PSF, location range of the n-PSF (to prevent long DP data transmission latency).

S9.4, according to the PSF selection requirements, the TCF selects an n-PSF from the PSF(s) managed by it.

In some embodiment, TCF can select the n-PSF from PSFs managed by the TCF based on the computing resources required for executing of the target sub-task (such as minimal available resources in the re-location request) and/or the network location of the PSFs.

For example, the TCF may select the PSF whose available computing resources are greater than those required for executing the target sub-task and which has the shortest network distance to the o-PSF as the n-PSF. In this way, the network delay during the PSF re-location can be reduced and the re-location efficiency can be improved.

For another example, TCF may adopt the PSF among the managed PSFs that has available computing resources greater than the computing resources required by the target sub-task and has the shortest average network distance to the r-PSF as the n-PSF. In this way, the delay of data transmission during the execution of the target sub-task by the n-PFS can be reduced and the execution efficiency of the target sub-task can be improved.

S9.5, n-PSF info update from TCF to MM: notify the MM about the selected n-PSF info, including: ID/name of the n-PSF, location of the n-PSF, etc.

S9.6, as same as step S8.4 in MM enabled PSF re-location procedure.

After receiving n-PSF info update, MM can trigger TE customization procedure(s). In this way, the MM can control r-PSF through the corresponding r-TCF to suspend the currently executing task, and adjust the data forwarding relationship with the o-PSF to the data forwarding relationship with the n-PSF.

S9.7, n-PSF info update response from MM to TCF: confirm the n-PSF selected by the TCF. The TCF may further triggers the following steps after receiving this response.

S9.8, as same as step S8.6 in MM enabled PSF re-location procedure.

In some embodiments, after receiving the PSF re-location request, the TCF may trigger TE customization procedure(s) for all on-going TE(s) impacted by the PSF re-location. This step is optional. That is, the TCF may trigger r-PSF(s) managed by it to suspend execution of sub-task(s) associated with the target sub-task, and trigger the r-PSF(s) managed by it to adjust the data forward relationship with the o-PSF to a data forward relationship with the n-PSF.

In some embodiments, if there is at least one r-PSF existed in PSF(s) managed by TCF, the TCF may trigger TE customization procedure(s) for all on-going r-PSF(s) after receiving the info update response from MM. For details, please refer to the aforementioned step S8.6.

In some embodiments, if there is none r-PSF existed in PSF(s) managed by TCF, step S9.8 may be ignored.

S9.9, as same as step S8.7 in MM enabled PSF re-location procedure.

TCF triggers the n-PSF configuration procedure to configure the n-PSF with PSF execution parameters in response to the n-PSF info update response or after the TE customization procedure(s) completed.

S9.10, as same as step S8.8 in MM enabled PSF re-location procedure.

TCF may establish a temporary data session between the o-PSF and n-PSF, and triggers a PSF synchronization procedure to synchronize the o-PSF execution data to the n-PSF.

S9.11, as same as step S8.9 in MM enabled PSF re-location procedure.

PSF may send a re-location request response to TCF after the o-PSF execution data synchronized to the n-PSF.

In some embodiments, MM may send a resume execution request to r-TCF to instruct r-TCF to resume execution of the managed r-PSF after receiving the re-location response.

The following describes the process of TE customization.

As shown in FIG. 10, a method for TE customization is provided in this disclosure.

In a ME process, the MM may trigger the TE customization procedure to customize the execution of an on-going TE. The TE customization procedure can be involved in both PSF and TCF re-location procedures. FIG. 10 shows the TE customization procedure, which include:

S10.1, TE customize request from MM to TCF (managing the TE): trigger a TE customization procedure. This message may include at least one of:

Information identifying the TE (e.g., TE ID, (ID of the CBI running the TE+ mission session ID)).

Customization content: ID(s)/description(s)/parameter(s) to represent a customization purpose/behavior. (e.g., change current policies and/or QoS requirements of the TE, pause/resume TCF/PSF execution, change the DP data forwarding destination of a PSF after a scheduled time).

In some embodiments, the MM can send a TE customize request (also called PSF customize request, task execution customize request or task execution customize request) to r-TCF after n-PSF is determined. For example, in the processing flow shown in FIG. 8, the MM can send a TE customize request to the r-TCF after determining the n-PSF. For another example, for the processing flow shown in FIG. 9, the MM can send a TE customize request to r-TCF after receiving the n-PSF info update sent by TCF.

In some embodiments, the TE customize request may include PSF information (such as PSF identification, network address, etc.) and customization content of o-PSF and n-PSF.

For example, in the aforementioned situations shown in FIG. 7A to FIG. 7C, after determining that PSF 024 is adopt as n-PSF, MM 01 may send a TE customize request to TCF 03 and TCF 04 respectively to instruct TCF 03 to perform PSF customization on PSF 031 and instruct TCF 04 to perform PSF customization on PSF 042.

In some embodiments, PSF customization may include at least one of the following operations: suspend or resume sub-tasks (or TEs) executed by PSF; adjusting the source address for obtaining data of PSF; adjusting the destination address for outputting data of PSF.

S10.2, TCF customization: according to the received customize content, the TCF may customize its local configurations (e.g., policies and/or QoS requirements for the TE).

In some embodiments, the policies in the local configurations may comprise information/rule(s) required to enable the execution control of the TE, and/or information/rule(s) for charging the data flow of the TE.

S10.3, PSF execution customization: According to the received customize content, the TCF may triggers the PSF execution customization procedure to: 1) modify the configuration of PSF(s) (e.g., change DP data forwarding destination); 2) request the PSF(s) executing specific behaviors (e.g., pause/resume PSF execution). The sub-steps of the PSF execution customization procedure include:

S10.3.1, PSF execution customize request from TCF to PSF: request the PSF to customize its execution behavior(s) or modify its configuration(s). This message may include: ID(s)/description(s)/parameter(s) to represent a customization purpose/behavior. (e.g., pause/resume the PSF execution, change the DP data forwarding destination of to a new PSF after a scheduled time).

For example, for the aforementioned situations shown in FIGS. 7A to 7C, TCF 03 can send a PSF execution customize request to the r-PSF (PSF 031) corresponding to PSF 023 after receiving the task execution customize request. TCF 04 can send a PSF execution customize request to the r-PSF (PSF 042) corresponding to PSF 023 after receiving the task execution customize request.

In some embodiments, the PSF execution customize request may also be called PSF execution customize request.

In some embodiments, the PSF execution customize request further instructs the r-PSF to resume execution of the suspended sub-task after suspended for a certain duration.

S10.3.2, after receiving the PSF execution customize request in step 3.1, the PSF customize its execution behavior(s)/configuration(s) accordingly.

For example, for the aforementioned situations shown in FIG. 7A to FIG. 7C, PSF 031 can suspend the execution of sub-task TE2.1, and adjust the source address for receiving the input data of sub-task TE2.1 from the network address of PSF 023 to the network address of PSF 024 after receiving the PSF execution customize request. PSF 042 can suspend the execution of sub-task TE4.2 and adjust the source address for receive the input data of sub-task TE4.2 from the network address of PSF 023 to the network address of PSF 024 after receiving the PSF execution customize request.

S10.3.3, PSF execution customize request response from PSF to TCF: inform the TCF about the completion of PSF execution customization.

r-PSF may send a PSF execution customize request response to the corresponding r-TCF after the PSF execution customization is completed, wherein the PSF execution customize request response indicates that the PSF execution customization has been completed.

Illustratively, for the aforementioned situation shown in FIG. 7A to FIG. 7C, PSF 031 may can send PSF execution customize request response to TCF 03 after the execution of sub-task TE2.1 were suspended and the source address of for receiving the input data of sub-task TE2.1 was adjusted to the network address of PSF 024. PSF 042 may can send PSF execution customize request response to TCF 04 after the execution of sub-task TE4.2 were suspended and the source address of for receiving the input data of sub-task TE4.2 was adjusted to the network address of PSF 024.

In some embodiments, if the PSF execution customize request instructs the r-PSF to resume execution of the suspended sub-task after suspended for a certain duration, the r-PSF may resume execution of the suspended sub-task after suspended for the certain duration.

S10.4, (opt.) TCF customization: the TCF may further customizes its local configurations after the PSF execution customization procedure completed (e.g., pause/resume TCF execution).

S10.5, TE customize request response from TCF to MM: inform the MM about the completion of the TE customization.

The r-TCF may send a task execution customize request response (TE customize request response) to the MM to instruct the MM to perform further operations after receiving the PSF execution customize request response sent by the corresponding r-PSF.

For example, for the execution procedure shown in FIG. 8, after receiving the task execution customize request response (step S8.4), the MM can perform step S8.5: send a PSF re-location request to the TCF that manages o-PSF. For another example, for the execution procedure shown in FIG. 9, after receiving the task execution customize request response (step S9.6), the MM can perform step S9.7: send n-PSF info update request response to the TCF that manages o-PSF.

In some embodiments, at least parts of functions of PSF, TCF and MM may be embedded into one or more chips or chipsets. The disclosure provides one or more chips or chipsets realizing at least parts of functions of PSF, TCF, or MM by executing instructions or corresponding circuits.

Referring to FIG. 11, FIG. 11 shows a schematic block diagram of an apparatus according to some embodiments of this disclosure. The apparatus 1000 includes a processor 1010. The processor 1010 may be coupled to a memory 1020. The memory 1020 is configured to store a computer program or instructions and/or data. The processor 1010 is configured to execute the computer program or instructions and/or data stored in the memory 1020, so that the methods in the foregoing method embodiments are executed.

In some embodiments, the apparatus 1000 includes one or more processors 1010.

In some embodiments, as shown in FIG. 11, the apparatus 1000 may further include the memory 1020.

In some embodiments, the apparatus 1000 may include one or more memories 1020.

In some embodiments, the memory 1020 may be integrated with the processor 1010, or disposed separately from the processor 1010.

In some embodiments, as shown in FIG. 11, the apparatus 1000 may further include a transceiver 1030, and the transceiver 1030 is configured to receive and/or transmit a signal to other apparatus 1000. For example, the processor 1010 is configured to control the transceiver 1030 to receive and/or transmit a signal.

In some embodiments, the detail description of processor 1010 may refer to the aforementioned processor 210/260/276.

In some embodiments, the detail description of memory 1020 may refer to the aforementioned memory 208/258/278.

In some embodiments, the detail description of transceiver 1030 may refer to the aforementioned transmitter 201/252/272 and receiver 203/254/274.

In some embodiments, the apparatus 1000 may comprise more modules.

In some embodiments, the apparatus 1000 may deploy one or more PSFs, and/or one or more TCFs, and/or one or more MMs.

In some embodiments, in case the apparatus 1000 deploy a TCF managing the o-PSF, the apparatus 1000 may execute instructions to realize the steps executed by TCF in FIGS. 8 and 9.

In some embodiments, in case the apparatus 1000 deploy a MM, the apparatus 1000 may execute instructions to realize the steps executed by MM in FIGS. 8, 9 and 10.

In some embodiments, in case the apparatus 1000 deploy a r-TCF managing the r-PSF, the apparatus 1000 may execute instructions to realize the steps executed by r-TCF in FIGS. 8, 9 and 10.

In some embodiments, in case the apparatus 1000 deploy an o-PSF or n-PSF, the apparatus 1000 may execute instructions to realize the steps executed by o-PSF or n-PSF in FIGS. 8 and 9.

In some aspects of the present disclosure, there is provided an apparatus/chipset system comprising means (e.g., apparatus/chipset system comprising at least one processor) to implement a method implemented by (or at) the PSF, TCF and MM. The apparatus/chipset system may be a UE (that is, a terminal device), a base station, an edge device, a server or a module/component in those device. In details, the at least one processor may execute instructions stored in a computer-readable medium to implement the method.

The TE customization procedure enables the dynamic customization of execution behavior(s) in a TE during the ME process.

In some aspects of the present disclosure, there is provided an apparatus/chipset system comprising means (e.g., at least one processor) to implement a method implemented by (or at) a UE of the present disclosure. The apparatus/chipset system may be the UE (that is, a terminal device) or a module/component in the UE. In details, the at least one processor may execute instructions stored in a computer-readable medium to implement the method.

In some aspects of the present disclosure, there is provided an apparatus/chipset system comprising means (e.g., at least one processor) to implement the method implemented by (or at) a network device (e.g., base station) of the present disclosure. The apparatus/chipset system may be the network device or a module/component in the network device. In details, the at least one processor may execute instructions stored in a computer-readable medium to implement the method.

In some aspects of the present disclosure, there is provided a system comprising at least one of an apparatus in (or at) a UE of the present disclosure, or an apparatus in (or at) a network device of the present disclosure.

In some aspects of the present disclosure, there is provided a method performed by a system comprising at least one of an apparatus in (or at) a UE of the present disclosure, and an apparatus in (or at) a network device of the present disclosure.

In some aspects of the present disclosure, there is provided an apparatus/chipset system comprising means (e.g., at least one processor) to implement a method implemented by (or at) a UE of the present disclosure. The apparatus/chipset system may be a network entity illustrated in this disclosure, e.g., AF, TCF, Device (that is, a terminal device) or a module/component in the network entity. In details, the at least one processor may execute instructions stored in a computer-readable medium to implement the method.

In some aspects of the present disclosure, there is provided a system comprising at least two of the mentioned network entities e.g., AF, TCF, Device illustrated in this disclosure.

In some aspects of the present disclosure, there is provided a method performed by a system comprising at least two of the mentioned network entities illustrated in this disclosure.

In some embodiments, two or more of the network entities illustrated in this disclosure may be located in in physical network entity, or to be implemented as a single function entity. In this case, the interaction between the two or more of the mentioned network entities may be not needed, i.e., the corresponding step(s) may be ignored (optional).

In some embodiments, although two or more network entities are illustrated in this disclosure, only one of them may be enough for an example solution in this disclosure.

In some aspects of the present disclosure, there is provided a computer program comprising instructions. The instructions, when executed by a processor, may cause the processor to implement a method of the present disclosure.

In some aspects of the present disclosure, there is provided a non-transitory computer-readable medium storing instructions, the instructions, when executed by a processor, may cause the processor to implement a method of the present disclosure.

The solutions described in the disclosure is applicable to a next generation (e.g. sixth generation (6G) or later) network, or a legacy (e.g. 5G, 4G, 3G or 2G) network.

It will be appreciated that any module, component, or device disclosed herein that executes instructions may include, or otherwise have access to, a non-transitory computer/processor readable storage medium or media for storage of information, such as computer/processor readable instructions, data structures, program modules and/or other data. A non-exhaustive list of examples of non-transitory computer/processor readable storage media includes magnetic cassettes, magnetic tape, magnetic disk storage or other magnetic storage devices, optical disks such as compact disc read-only memory (CD-ROM), digital video discs or digital versatile discs (i.e., DVDs), Blu-ray Disc™, or other optical storage, volatile and non-volatile, removable and non-removable media implemented in any method or technology, random-access memory (RAM), read-only memory (ROM), electrically erasable programmable read-only memory (EEPROM), flash memory or other memory technology. Any such non-transitory computer/processor storage media may be part of a device/apparatus or accessible or connectable thereto. Computer/processor readable/executable instructions to implement a method, an application or a module described herein may be stored or otherwise held by such non-transitory computer/processor readable storage media.

It could be noted that the message in the disclosure could be replaced with information, which may be carried in one single message, or be carried in more than one separate message.

Without special noting, the terms “apparatus” and “device” are used exchangeable, and the terms “identity” and “identifier” are sued exchangeable.

In the disclosure, the word “a” or “an” when used in conjunction with the term “comprising” or “including” in the claims and/or the specification may mean “one”, but it is also consistent with the meaning of “one or more”, “at least one”, and “one or more than one” unless the content clearly dictates otherwise. Similarly, the word “another” may mean at least a second or more unless the content clearly dictates otherwise.

In the disclosure, the words “first”, “second”, etc., when used before a same term (e.g., ED, or an operating step) does not mean an order or a sequence of the term. For example, the “first ED” and the “second ED”, means two different EDs without specially indicated, and similarly, although the present disclosure describes methods and processes with steps in a certain order, one or more steps of the methods and processes may be omitted or altered as appropriate. One or more steps may take place in an order other than that in which they are described, as appropriate. For example, the “first step” and the “second step” means two different operating steps without specially indicated, but does not mean the first step have to happen before the second step. The real order depends on the logic of the two steps.

The terms “coupled”, “coupling” or “connected” as used herein can have several different meanings depending on the context in which these terms are used. For example, as used herein, the terms coupled, coupling, or connected can indicate that two elements or devices are directly connected to one another or connected to one another through one or more intermediate elements or devices via a mechanical element depending on the particular context.

Note that the expression “at least one of A or B”, as used herein, is interchangeable with the expression “A and/or B”. It refers to a list in which you may select A or B or both A and B. Similarly, “at least one of A, B, or C”, as used herein, is interchangeable with “A and/or B and/or C” or “A, B, and/or C”. It refers to a list in which you may select: A or B or C, or both A and B, or both A and C, or both B and C, or all of A, B and C. The same principle applies for longer lists having a same format.

The present disclosure encompasses various embodiments, including not only method embodiments, but also other embodiments such as apparatus embodiments and embodiments related to non-transitory computer readable storage media. Embodiments may incorporate, individually or in combinations, the features disclosed herein.

The term “receive”, “detect” and “decode” as used herein can have several different meanings depending on the context in which these terms are used. For example, without special note, the term “receive” may indicate that information (e.g., DCI, or MAC-CE, RRC signaling or TB) is received successfully by the receiving node, which means the receiving side correctly detect and decode it. In this scenario, “receive” may cover “detect” and “decode” or may indicates same thing, e.g., “receive paging” means decoding paging correctly and obtaining the paging successfully, accordingly, “the receiving side does not receive paging” means the receiving side does not detect and/or decoding the paging. “paging is not received” means the receiving side tries to detect and/or decoding the paging, but not obtain the paging successfully. The term “receive” may sometimes indicate that a signal arrives at the receiving side, but does not mean the information in the signal is detected and decoded correctly, then the receiving side need perform detecting and decoding on the signal to obtain the information carried in the signal. In this scenario, “receive”, “detect” and “decode” may indicate different procedure at receiving side to obtain the information.

Although this disclosure refers to illustrative embodiments, this is not intended to be construed in a limiting sense. Various modifications and combinations of the illustrative embodiments, as well as other embodiments of the disclosure, will be apparent to persons skilled in the art upon reference to the description. When combining two or more embodiments, not all the features in the embodiments to be combined are necessary for the combination.

Features disclosed herein in the context of any particular embodiments may also or instead be implemented in other embodiments. Method embodiments, for example, may also or instead be implemented in apparatus, system, and/or computer program product embodiments. In addition, although embodiments are described primarily in the context of methods and apparatus, other implementations are also contemplated, as instructions stored on one or more non-transitory computer-readable media, for example. Such media could store programming or instructions to perform any of various methods consistent with the present disclosure.

What is claimed is:

1. A method comprising:
receiving, from a mission management (MM) network element in a communication system, a re-location request, wherein the MM network element is configured to manage execution of a first mission, and a first sub-task in a first task of the first mission is executed on a first processing service function (PSF) network element; and
switching the first sub-task to a second PSF network element for execution in response to the re-location request, wherein the first PSF network element and the second PSF network element are managed by a task control function (TCF) network element in the communication system.

2. The method of claim 1, wherein the switching the first sub-task to the second PSF network element for execution comprises:
sending, to the first PSF network element, a first synchronization request instructing the first PSF network element to synchronize execution data of the first sub-task with the second PSF network element.

3. The method of claim 2, wherein the switching the first sub-task to the second PSF network element for execution comprises:
sending, to the second PSF network element, a second synchronization request instructing the second PSF network element to obtain the execution data of the first sub-task from the first PSF network element.

4. The method of claim 2, wherein the execution data comprises at least one of:
PSF network element information of a PSF network element executing a task associated with the first sub-task;
execution progress of the first sub-task; or
intermediate data obtained by the first PSF network element by executing the first sub-task.

5. The method of claim 3, further comprising:
prior to either sending the first synchronization request to the first PSF network element or sending the second synchronization request to the second PSF network element, sending, to the second PSF network element, a first configuration request instructing the second PSF network element to configure an execution parameter.

6. The method of claim 5, wherein the execution parameter comprises at least one of a session identifier of a connected data session, a data forwarding rule, or a data synchronization rule.

7. The method of claim 5, further comprising:
prior to sending the first configuration request to the second PSF network element, sending, to one or more third PSF network elements, a first PSF execution customize request,
wherein the first PSF network element and the one or more third PSF network elements are managed by the same TCF network element, each of the one or more third PSF network elements executes a second task associated with the first sub-task, and the first PSF execution customize request instructs the one or more third PSF network elements to suspend execution of the second task.

8. The method of claim 7, wherein the first PSF execution customize request further instructs the one or more third PSF network elements to perform at least one of the following operations:
switching a first data forwarding relationship with the first PSF network element to a second data forwarding relationship with the second PSF network element; or
resuming execution of the second task, the second task having been suspended for a first duration.

9. The method of claim 7, wherein the first configuration request is sent to the second PSF network element after receiving a response corresponding to the first customize request.

10. The method of claim 7, further comprising:
receiving, from at least one of the first PSF network element or the second PSF network element, a synchronization response; and
in response to the synchronization response, sending, to the MM network element, a re-location response instructing the MM network element to resume execution of a third task,
wherein the third task was suspended prior to switching the first sub-task to the second PSF network element for execution, the third task associated with the first sub-task.

11. The method of claim 7, further comprising:
receiving, from at least one of the first PSF network element or the second PSF network element, a synchronization response; and
sending, to the one or more third PSF network elements, a resume execution request instructing the one or more third PSF network elements to resume execution of the second task.

12. The method of claim 1, wherein:
the second PSF network element is determined based on one or more performance parameters associated with corresponding PSF network elements managed by the TCF network element; and
the one or more performance parameters comprise at least one of: available communication resources, available computing resources, or a network location.

13. The method of claim 1, wherein the re-location request comprises a first identifier of the first PSF network element and a second identifier of the second PSF network element.

14. A method comprising:
determining that a first processing service function (PSF) network element in a communication system meets a re-location condition, wherein the first PSF network element executes a first sub-task, the first sub-task is a sub-task within a mission managed by a mission management (MM) network element, and the first PSF network element is managed by a first task control function (TCF) network element in the communication system; and
sending a re-location request to the first TCF network element, wherein the re-location request instructs the first TCF network element to switch the first sub-task from the first PSF network element to a second PSF network element for execution, wherein the second PSF network element is managed by the first TCF network element.

15. The method of claim 14, wherein the re-location request comprises an identifier of the second PSF network element, wherein the second PSF network element is determined by the MM network element based on one or more performance parameters associated with corresponding PSF network elements managed by the first TCF network element.

16. The method of claim 14, wherein the re-location request instructs the first TCF network element to determine the second PSF network element from PSF network elements managed by the first TCF network element, and switch the first sub-task to the second PSF network element for execution.

17. The method of claim 16, further comprising:
receiving, from the first TCF network element, a second identifier of the second PSF network element; and
sending, to one or more second TCF network elements managing one or more fourth PSF network elements executing a third task, a task execution customize request,
wherein the third task is associated with the first sub-task, and the task execution customize request instructs the one or more second TCF network elements to suspend execution of the third task.

18. The method of claim 17, further comprising:
receiving a re-location request response from the first TCF network element; and
sending, to the one or more second TCF network elements, a resume execution request instructing the one or more second TCF network elements to control a corresponding fourth PSF network element to resume execution of the third task.

19. The method of claim 14, wherein the re-location condition comprises at least one of the following conditions:
an available communication resource of the first PSF network element being less than a first threshold;
an available computing resource of the first PSF network element being less than a second threshold; or
determining to execute a load balancing policy on a network entity corresponding to the first PSF network element.

20. A communication method applied to a communication system, the communication system comprising a mission management (MM) network element, a task control function (TCF) network element managed by the MM network element, and a first processing service function (PSF) network element and a second PSF network element both managed by the TCF network element, the first PSF network element executing a first sub-task in a first task of a first mission managed by the MM network element, the communication method comprising:
determining, by the MM network element, that the first PSF network element meets a re-location condition;
sending, by the MM network element, a re-location request to the TCF network element; and
in response to receiving the re-location request, switching, by the TCF network element, the first sub-task to the second PSF network element for execution.
